(19) United States
(12) Patent Application Publication
(10) Pub. No.: US 2024/0193593 A1
(43) Pub. Date: Jun. 13, 2024

(54) CHAIN STRUCTURE ADDRESS GENERATION METHOD, TRANSACTION DATA PROCESSING METHOD, APPARATUS, AND STORAGE MEDIUM

(71) Applicant: Jieqian Zheng, Guiyang, Guizhou (CN)

(72) Inventor: Jieqian Zheng, Gulyang (CN)

(21) Appl. No.: 18/286,639

(22) PCT Filed: Jan. 7, 2022
(86) PCT No.: PCT/CN2022/070736

§ 371 Date: Oct. 12, 2023

(30) Foreign Application Priority Data
Apr. 29, 2021 (CN) 202110474716.5
Aug. 13, 2021 (CN) 202110931943.6

(51) Int. Cl. G06Q 20/38; G06Q 20/02

(52) U.S. Cl. CPC G06Q 20/3827; G06Q 20/02; G06Q 20/3825

(57) ABSTRACT

A chain structure address generation method, a transaction data processing method, an apparatus, and a storage medium. The chain structure address generation method comprises: determining a unique identifier of a first main body; generating an address, the address comprising the type of the address and the unique identifier of the first main body, and the address being used when the first main body participates in transaction, such that a TXO transaction data chain generated by the first main body is logically isolated from TXO transaction data chains generated by other main bodies. The transaction data processing method comprises: merging a TXO transaction data chain generated by a first main body and TXO transaction data chains generated by other member main bodies, which belong to a same consortium blockchain with the first main body, to form TXO transaction data chain of the consortium blockchain.

### CROSS-REFERENCE TO RELATED APPLICATIONS

The present application is a U.S. National Phase Entry of International Application No. PCT/CN2022/070736 having an international filing date of Jan. 7, 2022, which claims priorities to Chinese patent application No. CN202110474716.5, filed to the CNIPA on Apr. 29, 2021 and entitled “Chain Structure Address Generation Method, Transaction Data Processing Method, Apparatus, and Storage Medium”, and Chinese patent application No. CN202110931943.6, filed to the CNIPA on Aug. 13, 2021 and entitled “Chain Structure Processing, Transaction Data Processing, Data Verification Method, Apparatus, and Medium”. The contents of the above-identified applications are hereby incorporated by reference.

### TECHNICAL FIELD

Embodiments of the present disclosure relate to, but are not limited to, the field of computer data processing technologies, in particular to an address generation method in a chain structure, a transaction data processing method, an apparatus, and a storage medium.

### BACKGROUND

Blockchain includes Public blockchain, Private blockchain, and Consortium blockchain.

Among them, the private blockchain is only open to a single individual or entity. The consortium blockchain is only open to members of a specific group and limited third parties, within which multiple pre-selected nodes are designated as bookkeepers, and generation of each block is jointly decided by all pre-selected nodes.

### SUMMARY

The following is a summary of subject matters described in detail herein. This summary is not intended to limit the scope of protection of claims.

In one aspect, an embodiment of the present disclosure provides a chain structure transaction data processing method, the method includes: merging a Transaction Output (TXO) transaction data chain generated by a first subject and a TXO transaction data chain generated by another member subject belonging to a same consortium blockchain as the first subject to form a TXO transaction data chain of the consortium blockchain; when the first subject participates in a transaction to generate transaction data, the transaction data contains a unique identifier of the first subject, to enable the TXO transaction data chain generated by the first subject to be logically isolated from a TXO transaction data chain generated by another subject.

In an exemplary embodiment, the merging the TXO transaction data chain generated by the first subject and the TXO transaction data chain generated by another member subject belonging to the same consortium blockchain as the first subject to form the TXO transaction data chain of the consortium blockchain, includes: merging permission chain ledger data of the first subject and permission chain ledger data of another member subject of the consortium blockchain to generate ledger data of the consortium blockchain, wherein the ledger data of the consortium blockchain logically contains transaction data of a subject; the permission chain ledger data contains transaction data of the subject.

In an exemplary embodiment, before the merging the TXO transaction data chain generated by the first subject and the TXO transaction data chain generated by another member subject belonging to the same consortium blockchain as the first subject, the method further includes: verifying, by a verifier, permission chain block data; after being verified as passed, adding a block header hash value for indicating a restricted block position to permission chain block header data to be put on-chain, wherein the restricted consortium blockchain block position is at least a maximum block position corresponding to an unspent output on the consortium blockchain referenced by a cross-permission chain transaction in the permission chain block; and endorsing and signing the permission chain block header data added with the block header hash value for indicating the restricted consortium blockchain block position.

In an exemplary embodiment, the adding the block header hash value for indicating the restricted block position to the permission chain block header data to be put on-chain includes: when the permission chain block to be put on-chain does not contain a cross-permission chain transaction, recursively forwarding to a previous permission chain block containing a cross-permission chain transaction on the permission chain, finding a permission chain block header pointing to the permission chain block on the consortium blockchain, and adding a block header hash value in the permission chain block header for indicating a restricted consortium blockchain block position to permission chain block header data to be put on-chain at present; or when the permission chain block to be put on-chain does not contain a cross-permission chain transaction, recursively forwarding to a permission chain block containing a cross-permission chain transaction on the permission chain, and adding a second preset value to permission chain block header data to be put on-chain at present.

In an exemplary embodiment, the method further includes: setting the block header hash value for indicating the restricted consortium blockchain block position in the permission chain block header data to be put on-chain to a first preset value when recursively forwarding to an originating block, which still does not contain a cross-permission chain transaction, on the permission chain.

In an exemplary embodiment, the merging the TXO transaction data chain generated by the first subject and the TXO transaction data chain generated by another member subject belonging to the same consortium blockchain as the first subject, includes: generating a first layer of ledger data of the consortium blockchain after performing consensus on a plurality of permission chain block header data which are endorsed and signed, wherein transaction data corresponding to block header data of the permission chain is used as a second layer of ledger data of the consortium blockchain.

In an exemplary embodiment, the generating the first layer of ledger data of the consortium blockchain after performing consensus on the plurality of permission chain block header data which are endorsed and signed, includes: consensus-putting on-chain, by a bookkeeper, information to be put on-chain which meets a condition and is generated by the verifier, wherein the condition includes, but is not limited to: being verified by more than a preset number of verifiers as passed, meeting a requirement for a restricted block position, and being endorsed and signed by the verifier; wherein the meeting the requirement for the restricted block position, includes: a block header hash value, corresponding to a permission chain block header to be put on-chain on the consortium blockchain, indicating a restricted consortium blockchain block position is equal to one of forward consortium blockchain block header hash values; permission chain block headers are sequentially put on-chain on the consortium blockchain, and a first block header data of a permission chain put on-chain on the consortium blockchain contains a first preset value.

In an exemplary embodiment, the merging the permission chain ledger data of the first subject and the permission chain ledger data of another member subject of the consortium blockchain, includes: verifying, by another member subject, transaction data contained in block body data in the permission chain ledger data of the first subject as passed; verifying, by another member subject, permission chain block header data corresponding to the block body data as passed and signing, wherein the permission chain block header data contains a unique identifier of a subject; and merging and performing consensus on the permission chain block header data of the first subject that has been verified as passed and permission chain block header data of another member subject that has been verified as passed, wherein merged permission chain block header data is used as block body data of the consortium blockchain.

In an exemplary embodiment, the method further includes: verifying, by the first subject, transaction data contained in block body data in permission chain ledger data of another member subject belonging to a same consortium blockchain as the first subject and permission chain block header data corresponding to the block body data, wherein verifying transaction data in the block body data includes one or more of following: verifying whether transaction data is correct; whether an input reference address and an output address contain an identifier of a verified subject; whether a cross-chain transaction address contains an identifier of a receiving subject, which is an identifier of a verified subject, and whether a cross-chain transaction address referenced by an input is an unspent transaction output put on-chain on the consortium blockchain.

In another aspect, an embodiment of the present disclosure also provides an address generation method in a chain structure, including: determining a unique identifier of a first subject; generating an address, wherein the address contains a type of the address and a unique identifier of the first subject; the address is used when the first subject participates in a transaction, to enable a Transaction Output (TXO) transaction data chain generated by the first subject to be logically isolated from a TXO transaction data chain generated by another subject.

In an exemplary embodiment, the transaction in which the first subject participates includes: a first transaction between a first user managed by the first subject and the first subject, and a second transaction between the first subject and a second subject, generated by the first subject according to the first transaction, the second transaction is used for enabling the second subject to generate a third transaction between the second subject and a second user managed by the second subject to achieve a transaction between the first user and the second user.

In an exemplary embodiment, an input of the first transaction is an unspent transaction output of the first user, an output of the first transaction includes an intermediate transaction address, a commitment address of the first user, and a commitment address of the second user.

In an exemplary embodiment, an input of the second transaction includes one or more references to the first transaction, an output of the second transaction includes a cross-chain transaction address of the second subject and an output commitment address of the second user, and the cross-chain transaction address is used for the second subject to reference in an input of the third transaction.

In an exemplary embodiment, when the first subject is a member of a consortium blockchain, the method further includes: merging a TXO transaction data chain generated by the first subject and a TXO transaction data chain generated by another member subject of the consortium blockchain to form a TXO transaction data chain of the consortium blockchain.

In an exemplary embodiment, the address includes one or more of following: a user address, wherein the generated user address includes: an address type for indicating that a current address is a user address, a unique identifier of a current subject, and a primary address of a user; and a cross-chain transaction address, wherein the generated cross-chain transaction address includes: an address type for indicating that a current address is a cross-chain transaction address, a unique identifier of a current subject, a unique identifier of a cross-chain subject, and a unique number.

In an exemplary embodiment, the generated cross-chain transaction address further includes: a restricted cross-chain block height, referenced by the cross-chain subject within the restricted cross-chain block height or referenced by a current subject after the restricted cross-chain block height, after a second transaction generated by the current subject is put on-chain.

In yet another aspect, an embodiment of the present disclosure also provides a computer-readable storage medium storing program instructions, when the program instructions are executed, the address generation method and the transaction data processing method in the chain structure described above may be implemented.

In yet another aspect, an embodiment of the present disclosure also provides a blockchain institution, including a memory, a processor, and a computer program stored on the memory and runnable on the processor, the address generation method and the transaction data processing method in the chain structure described above may be implemented when the processor executes the program.

Other features and advantages of the present disclosure will be set forth in following specification and in part will become apparent from the specification or will be understood by practicing the present disclosure. Objects and other advantages of the present disclosure may be achieved and obtained by a structure particularly pointed out in the specification, the claims, and appended drawings.

After reading and understanding the drawings and detailed description, other aspects may be understood.

### BRIEF DESCRIPTION OF DRAWINGS

The drawings are intended to provide a further understanding of technical solutions of the present disclosure, constitute a part of the specification, and are used for explaining the technical solutions of the present disclosure together with the embodiments of the present disclosure, and are not intended to constitute limitations on the technical solutions of the present disclosure.

FIG. 1 is a flowchart of an address generation method in a chain structure according to an embodiment of the present disclosure.

FIG. 2 is a flowchart of a transaction data processing method according to an embodiment of the present disclosure.

FIG. 3a is a schematic diagram of a data structure of a consortium blockchain ledger according to an embodiment of the present disclosure.

FIG. 3b is an example diagram of consortium blockchain ledger data according to an embodiment of the present disclosure.

FIG. 4 is an example diagram of a Merkle tree with serial numbers according to an embodiment of the present disclosure.

FIG. 5 is a schematic diagram of a relationship between a private blockchain and a consortium blockchain according to an embodiment of the present disclosure.

FIG. 6 is a schematic diagram of a permission chain block header data put on-chain on a consortium blockchain according to an embodiment of the present disclosure.

FIG. 7 is a schematic diagram of an intermediate transaction generated by a first subject according to an embodiment of the present disclosure.

FIG. 8 is a schematic diagram of a structure of a computer apparatus according to an embodiment of the present disclosure.

### DETAILED DESCRIPTION

Multiple embodiments are described herein, but the description is exemplary rather than restrictive, and it is obvious to those of ordinary skill in the art that there may be more embodiments and implementation solutions within the scope of the embodiments described in the present disclosure. Although many possible feature combinations are shown in the drawings and discussed in specific implementation modes, many other combinations of disclosed features are possible. Unless expressly limited, any feature or element of any embodiment may be used in combination with, or may replace, any other feature or element in any other embodiment.

In the present disclosure, combinations of features and elements known to those of ordinary skill in the art are included and contemplated. Disclosed embodiments, features, and elements of the present disclosure may also be combined with any conventional feature or element to form a unique solution defined by the claims. Any feature or element of any embodiment may also be combined with features or elements from other solutions to form another unique solution defined by the claims. Accordingly, it should be understood that any of features shown and/or discussed in the present disclosure may be implemented individually or in any suitable combination. Thus the embodiments are not subject to limitations other than those made in accordance with the appended claims and their equivalent substitutions. In addition, various modifications and changes may be made within the protection scope of the appended claims.

In addition, when a representative embodiment is described, a method and/or process may already be presented in a specific order of acts in the specification. However, to the extent that the method or process does not depend on the specific order of the acts described herein, the method or process should not be limited to the acts with the specific order. As will be understood by those of ordinary skill in the art, another order of acts is also possible. Therefore, the specific order of the acts illustrated in the specification should not be interpreted as a limitation on claims. Moreover, claims directed to the method and/or process should not be limited to performing their acts in the described order, and those skilled in the art may readily understand that these orders may be varied and still remain within the spirit and scope of the embodiments of the present disclosure.

Acts illustrated in a flowchart of the drawings may be performed in a computer system such as a set of computer executable instructions. Although a logical order is shown in the flowchart, in some cases, the acts shown or described may be performed in a different order than herein.

A permission chain means that every node participating in a blockchain system is permitted. A node without permission cannot be allowed to access the system. According to an embodiment of the present disclosure, by using a unique identifier of a subject in an address, ledger data of the permission chain (private blockchain) generated by each subject will not conflict, and may be publicly verified without revealing privacy, so that a plurality of subjects may mutually verify ledger data (correctness verification), and after the verification is passed, the ledger data are directly merged and consensus-generated a consortium blockchain. That is to say, block data of a private blockchain of one subject are verified by a plurality of subjects, and are merged and packed to consensus-generate a consortium blockchain. Data of each subject is independent. For a participating subject, it is only necessary to verify whether its private blockchain is correct, and then ledger data may be merged and packed, which is beneficial for subjects without trust to participate with each other, such as different subjects in different countries and regions.

A permission chain may be considered as a blockchain belonging to a subject, the subject may contain one institution or several different member institutions. Bookkeeping of the permission chain is jointly completed by member institutions, and what is consensus-bookkept is transaction data within the subject. Each permission chain ledger may correspond to a subject, and does not share the ledger with other subjects. One subject is a management scope of one ledger, that is, one subject manages one ledger, and one subject may contain one or more member institutions. The permission chain ledger data of the subject contains transaction data, and token circulated within the subject is issued and managed by the subject itself. Without trust, a token of a certain subject cannot be freely circulated within any other subject.

Multiple subjects may participate to form a large consortium, that is, permission chain ledgers of multiple subjects may form a general ledger together, that is, a logical general ledger of a consortium blockchain may be obtained by merging permission chain ledgers of subjects. Since a permission chain restricts participation of a non-subject node, a ledger is not shared between subjects (including member subjects of the consortium), so the general ledger may only be logical, that is, only logically contains transaction data. What is consensus-bookkept by multiple subjects is block (header) data of the permission chain. Herein, the logical general ledger is referred to here as a consortium blockchain, and the permission chain of the subject may be referred to as a private blockchain. It may be seen that the two chains are different in ledger data. The permission chain (private blockchain) contains transaction data, and what is consensus-bookkept is transaction data; however, the consortium blockchain is only logical, and does not contain transaction data (which may be considered as logically inclusion or mapping), what is consensus-bookkept is the block (header) data of the permission chain.

Therefore, the permission chain may be very large and contain a lot of transaction data, while the consortium blockchain is very small, but it may logically contain multiple large-scale permission chain ledgers.

In order to achieve a logical general ledger (consortium blockchain) in an embodiment of the present disclosure, a general ledger may be formed by merging transaction data of permission chain ledgers of a plurality of subjects, and consensus-bookkeeping is carried out through fingerprint information of transaction data (set), that is, consensus-bookkeeping is carried out only through fingerprint information and additional information (such as a block header hash value that limits a block position) without transaction data (set), and a correct logical ledger is generated. Therefore, block data of multiple subjects without shared permission chain ledger and corresponding block header data (including fingerprint information of a block) may be consensus-merged into a logical general ledger of a consortium blockchain.

The above merging and consensus-bookkeeping are all based on transaction of an Unspent Transaction Output (UTXO) model, so the logical general ledger maps transaction data of the UTXO model.

Forming a logical general ledger may form a token (or referred to as a consortium token) of a general ledger, and the token cannot be issued and managed by any subject itself, but must be jointly issued and managed by consortium member subjects (or issued by a trusted subject and circulated by another subject). Therefore, compared with a token issued by a single subject, it has higher credibility and a larger circulation range, and may be freely circulated between permission chain ledgers of the consortium member subjects. And it may see from the present disclosure that the logical general ledger is a ledger of the consortium token, which reflects a circulation process of the consortium token, and what is merged is also the circulation process of the consortium token. Thereby free circulation of a token of a consortium between a plurality of consortium member subjects without shared ledgers is achieved, and a permission chain of one subject may participate in a plurality of different consortiums at the same time, circulate tokens of a plurality of consortiums, and merge into a plurality of different consortium blockchains.

Herein, a private blockchain in which one institution participates may be replaced by a permission chain in which multiple institutions participate, and the multiple institutions participating in the permission chain may be considered as one subject, that is, a private blockchain ledger of one institution in the following may be replaced by a permission chain ledger of one subject, and a related institution Identity (ID) is also a subject ID or chain ID. It may also be considered that one subject corresponds to one blockchain ledger, the subject may contain one institution or multiple institutions, and the blockchain ledger may be a private blockchain or a permission chain. Therefore, a private blockchain ledger of an institution in the following may be replaced by a permission chain ledger of a subject.

In an embodiment of the present disclosure, it is ensured that UTXO transaction data chain generated by each institution is conflict-free by setting relevant addresses when different institutions carry out transaction, and a cross-chain (private blockchain) transaction mode between related institutions is proposed. In addition, private blockchain ledger data may be merged into consortium blockchain ledger data, for example, consortium blockchain block data is consensus-generated through a private blockchain block header.

In an exemplary embodiment, transaction addresses generated by different institutions may be logically isolated from each other by including a unique institution ID of an institution in an address, so that a private blockchain of the institution may be merged after being verified to be correct. An output address of transaction data of a private blockchain of an institution includes an address containing an institution ID, an input reference address includes the address containing the institution ID, or includes a cross-chain transaction address and a cross-chain institution (i.e., a receiving institution) ID in the cross-chain transaction address is the institution ID. Therefore, each institution can generate a logically isolated Transaction Output (TXO) chain and can directly merge a ledger. In addition, in other embodiments, part of member subjects of a consortium can form a sub-consortium by themselves and generate a sub-consortium blockchain. Since only part of subjects participate in merge of sub-consortium blockchains, a cross-chain (private blockchain) transaction can be completed more quickly, and then sub-consortium blockchains participate in merging into a consortium blockchain. A sub-consortium blockchain is also a logical chain and does not contain transaction data. A difference between the sub-consortium blockchain and the consortium blockchain is that the sub-consortium blockchain does not have its own token, so it must circulate a token of the consortium.

That is, a UTXO chain (or referred to as a TXO transaction data chain) formed by transaction data of a private blockchain generated by an institution enables UTXO transaction data chains generated by different institutions to be logically isolated from each other by including an institution ID in a transaction address, and the logically isolated UTXO transaction data chains are connected through a cross-chain transaction address. A consortium blockchain ledger is to merge UTXO transaction data chain of a logically isolated private blockchain ledger into a larger UTXO chain. Since blockchain ledger data contains transaction data and the transaction data forms a UTXO transaction data chain, by merging ledger data of private blockchains generated by different institutions, it is achieved that a UTXO transaction data chain of a logically isolated private blockchain is merged into a UTXO transaction data chain of a consortium blockchain.

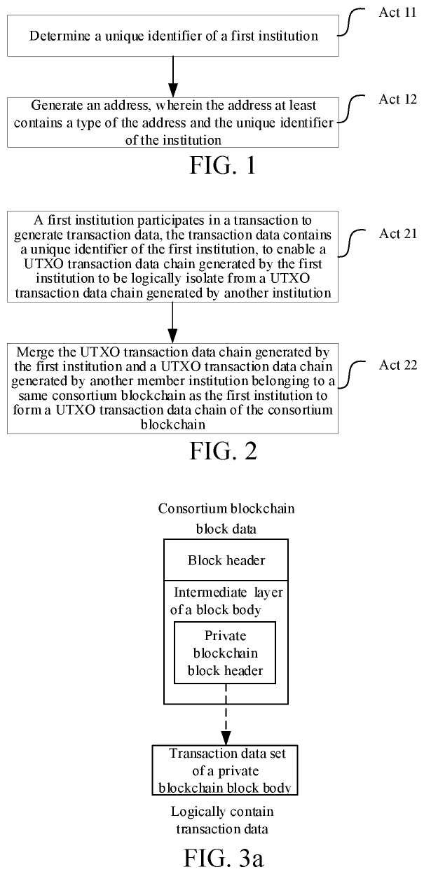

An address generation method in a chain structure provided by an embodiment of the present disclosure, as shown in FIG. 1, includes following acts.

Act 11, determining a unique identifier of a first institution.

Act 12, generating an address, wherein the address includes a type of the address and the unique identifier of the institution. The address is used when the first institution participates in a transaction, to enable a TXO transaction data chain generated by the first institution to be logically isolated from a TXO transaction data chain generated by another institution, that is, a UTXO chain formed by transaction data is logically isolated.

Since the address contains the unique identifier of the first institution, the transaction address generated by the first institution is isolated from a transaction address generated by another institution, and the TXO transaction data chain is formed by referencing an unspent transaction output (transaction address), thus it may be achieved that the TXO transaction data chain generated by the first institution is logically isolated from the TXO transaction data chain generated by another institution.

The TXO transaction data chain is a chain formed by transaction data obtained by an Unspent Transaction Output (UTXO) model, so it may also be called a UTXO transaction data chain. The TXO transaction data chain becomes spent by referencing one or more forward unspent outputs (transaction addresses), and one or more new unspent transaction outputs (transaction addresses) are created, which extends backward continuously and circularly, thereby forming a complex chain structure that may have multiple inputs and multiple outputs (different from a single input and a single output), i.e., a structure of a directed acyclic graph. Since this transaction data chain contains spent data (after being referenced) and unspent data, it is also referred to herein as a TXO transaction data chain, which has a same meaning as a UTXO transaction data chain in the following.

By adopting the address generation method in the chain structure of the embodiment of the present disclosure, by using the unique identifier of the institution in the address, private blockchain ledger data generated by each institution will not conflict, and data isolation of different private blockchains or different sub-private blockchains may be achieved.

In an exemplary embodiment, when a first institution and a second institution belong to different private blockchains (the first institution may be replaced with a first subject, corresponding to a first permission chain, and the second institution may be replaced with a second subject, corresponding to a second permission chain), a transaction (a cross-chain transaction) between a first user managed by the first institution and a second user managed by the second institution includes: a first transaction (or referred to as an intermediate transaction, a user address is input, and an intermediate transaction address is output) between the first user and the first institution, a second transaction (or referred to as an obfuscated transaction 2, an intermediate transaction address or/and a cross-chain transaction address is input, and a cross-chain transaction address is output, optionally a user address is output) between the first institution and the second institution, and a third transaction (or referred to as an obfuscated transaction 1, an intermediate transaction address or/and a cross-chain transaction address is input, and a user address is output) between the second institution and the second user. A transaction in which the first institution participates includes: the first transaction between the first user managed by the first institution and the first institution, and the second transaction between the first institution and the second institution generated by the first institution according to the first transaction, the second transaction is used for enabling the second institution to generate the third transaction between the second institution and the second user managed by the second institution to achieve a transaction between the first user and the second user.

In an exemplary embodiment, an input of the first transaction is an unspent transaction output of the first user, an output of the first transaction includes an intermediate transaction address (or referred to as an intermediate address), a commitment address of the first user, and a commitment address of the second user.

Herein, the intermediate transaction address includes at least a unique identifier of the first institution. The commitment address is an address used for performing a blockchain transaction. The commitment address may be a sum of a result of an operation between a user public key and a first coefficient and a result of an operation between a first generator and a second coefficient, and the operation is a one-way algorithm.

In an exemplary embodiment, the intermediate transaction address may be generated by a user, and the intermediate transaction address includes an address type used for indicating that a current address is an intermediate transaction address, a unique identifier and a unique number (e.g., a referenced user primary address) of the first institution. Optionally, the intermediate transaction address may be replaced by a primary address of a user, simply by changing the address type to an address type used for indicating that the current address is the intermediate transaction address. Since the primary address of the user is generated by an institution and is guaranteed to be unique, the intermediate transaction address may also be ensured to be unique after being replaced by an intermediate transaction address type. Or, the intermediate transaction address may be any unique number, for example, may be a random number.

In an exemplary embodiment, an input of the second transaction includes one or more references to the first transaction, and an output of the second transaction includes a cross-chain transaction address of the second institution and an output commitment address of the second user, the cross-chain transaction address is used for being referenced by the second institution in an input of the third transaction, i.e., the cross-chain transaction address is used for connecting logically isolated UTXO chains.

If a case that a plurality of users managed by the first institution transfer money to the second user occurs, the input of the second transaction includes references to a plurality of first transactions, each of the first transactions is a transaction initiated by a user managed by the first institution. If there is change, it may also include an output commitment address of the first user.

In an exemplary embodiment, when the first institution is a member of a consortium blockchain, the method further includes: merging UTXO transaction data chain generated by the first institution and a UTXO transaction data chain generated by another member institution (a member subject) of the consortium blockchain to form a UTXO transaction data chain of the consortium blockchain. That is, a UTXO transaction data chain of a first subject is merged with a UTXO transaction data chain of another member subject to form a UTXO transaction data chain of the consortium blockchain. For example, private blockchain ledger data of the first institution (permission chain ledger data of the first subject) and private blockchain ledger data of another member institution of the consortium blockchain (permission chain ledger data of another member subject) may be merged to generate ledger data of the consortium blockchain, thus achieving merging of logically isolated UTXO transaction data chains. Since a UTXO transaction data chain is formed by transaction data and the transaction data is stored in private blockchain ledger data of an institution generating the transaction data, that is, the private blockchain ledger data contains the transaction data of the institution, transaction data of ledgers may be merged by merging ledger data, thus achieving merging of UTXO transaction data chains which are formed by transaction data and are logically isolated.

The private blockchain ledger data of the first institution includes private blockchain block header data and private blockchain block body data, the private blockchain block header data includes the unique identifier of the first institution and fingerprint information corresponding to block body data, the private blockchain block body data includes a collection of transaction data of a private blockchain of the first institution, the transaction data forms a UTXO transaction data chain by referencing a unspent transaction output (a UXTO model), and the transaction data includes the unique identifier of the first institution.

In an exemplary embodiment, a private blockchain ledger of the first institution and a private blockchain ledger of another member institution of the consortium blockchain may be merged into a consortium blockchain ledger in a following way.

Merging block header data in the private blockchain ledger data of the first institution and block header data in the private blockchain ledger data of another member institution of the consortium blockchain to form block body data of the consortium blockchain, wherein ledger data of the consortium blockchain logically contains a transaction data of a subject. Since fingerprint information of block body data in a private blockchain ledger of a member institution of the consortium blockchain is contained, transaction data of private blockchain ledgers of member institutions of the consortium blockchain jointly forms a UTXO transaction data chain of the consortium blockchain, which may also be called a TXO transaction chain.

In an exemplary embodiment, transaction data contained in block body data in the private blockchain ledger data of the first institution is verified as passed by another member institution, and private blockchain block header data corresponding to the block body data is verified as passed and signed by another member institution. The private blockchain block header data contains a unique identifier of an institution to be logically isolated from private blockchain block header data of another institution. In addition, the private blockchain block header data also contains a fingerprint of previous block header data (a hash value of a block header) and a fingerprint of corresponding block body data (a hash value of a Merkle tree root). The private blockchain block header data of the first institution that has been verified as passed and the private blockchain block header data of another member institution that has been verified as passed are merged and are of consensus, and the merged private blockchain block header data is taken as block body data of the consortium blockchain.

In an exemplary embodiment, after another member institution verify transaction data in a block body of ledger data of the first institution as passed in an isolated environment, the another member institution may mark and verify corresponding private blockchain block header data as passed and sign it, and then the private blockchain block header data that has been marked and verified as passed and private blockchain block header data that has been verified as passed by another institution in a same way are merged and are of consensus (to reach a consensus after verifying data as correct, so as to obtain consistent and correct data) in a non-isolated environment, and the merged private blockchain block header data is taken as block body data of the consortium blockchain. A block body of the consortium blockchain does not contain actual transaction data, but block header data of a private blockchain, and private blockchain block body data (including its fingerprint), that is, actual transaction data, is mapped through the block header data of the private blockchain. In this way, a plurality of logically isolated private blockchain data are merged into consortium blockchain data. That is, a plurality of transaction data in one block body is regarded as one affair, which is composed of a plurality of inputs (all inputs of a plurality of transactions) and a plurality of outputs (all outputs of a plurality of transactions), and block header data contains fingerprint information of affair data, so merging block header data of a private blockchain is equivalent to merging affair data of the private blockchain.

In an exemplary embodiment, the method further includes: the first institution verifies transaction data contained in block body data in private blockchain ledger data of another member institution belonging to a same consortium blockchain as the first institution, and private blockchain block header data corresponding to the block body data, wherein verification of the transaction data in the block body data includes one or more of following: verifying whether transaction data is correct; whether an input reference address and an output address contain an identifier of a verified institution; whether a cross-chain transaction address contains an identifier of a receiving institution (the receiving institution refers to a receiving institution of a cross-chain transaction, such as the aforementioned second institution), that is, an identifier of a verified subject; whether a cross-chain transaction address referenced by an input is an unspent transaction output put on-chain on the consortium blockchain (that is, verify whether there is a member proof of the consortium blockchain). Whether a non-cross-chain transaction address referenced by an input is an unspent transaction output to be put on-chain on the consortium blockchain (i.e., verify whether there is a member proof of the private blockchain) or is an unspent transaction output put on-chain on the consortium blockchain, i.e., a cross-chain transaction needs to reference an unspent transaction output on the consortium blockchain, a non-cross-chain transaction may reference the unspent transaction output on the consortium blockchain or reference an unspent transaction output within the private blockchain to be put on-chain on the consortium blockchain.

In an exemplary embodiment, when merging, a following manner may also be adopted:
transaction data in a block body in ledger data of the first institution and transaction data in a block body in ledger data of the another member institution are merged, and consensus is reached on the merged transaction data, and transaction data after consensus is taken as block body data of consortium blockchain ledger data.

In an exemplary embodiment, the method further includes: when another consortium blockchain member institution issues tokens, the first institution verifies an amount of tokens issued by another consortium blockchain member institution, and signs issuance verification data corresponding to the tokens. The issuance verification data includes information such as an issuer's identifier and an issuance amount, and may also include a corresponding issuance address. The issuance verification data may be used for verifying whether an amount of tokens issued by issuance transaction data on a chain is correct.

In an exemplary embodiment, in the act 12 above, the generated address includes a user address, and the generated user address includes an address type indicating that a current address is a user address, a unique identifier of a current institution, and a primary address of a user. If the first institution executes the act 12, the current institution is the first institution, i.e., the user address of the user managed by the first institution includes a unique identifier of the first institution. The primary address of the user is generated by a primary public key of the user and is guaranteed to be unique.

In an exemplary embodiment, in the act 12 above, the generated address includes a cross-chain transaction address, the generated cross-chain transaction address includes an address type for indicating that a current address is a cross-chain transaction address, a unique identifier of a current institution (i.e., the first institution), a unique identifier and a unique number of a cross-chain institution (e.g., the second institution). The cross-chain transaction address is used for reference by the second institution. The cross-chain transaction address may be a random number. Logically isolated UTXO transaction data chains may be connected through the cross-chain transaction address, so that the logically isolated UTXO transaction data chains may be merged into a larger UTXO transaction data chain.

Taking a transaction between the first user managed by the first institution and the second user managed by the second institution as an example, for the first institution generating the cross-chain transaction address, the current institution is the first institution, the cross-chain institution is the second institution, and the first institution and the second institution correspond to different private blockchains.

In an exemplary embodiment, the generated cross-chain transaction address further includes: a restricted cross-chain block height, after the second transaction generated by the current institution is put on-chain, it is referenced by the cross-chain institution within the restricted cross-chain block height, or referenced by the current institution after the restricted cross-chain block height. Private blockchain conflicts may be prevented by setting the restricted cross-chain block height, it may be referenced by the second institution before the restricted block height and by the first institution after the restricted block height, i.e., it can only be referenced once by one institution.

An embodiment of the present disclosure also provides a transaction data processing method, as shown in FIG. 2, including following acts.

Act 21, when a first institution (a first subject) participates in a transaction to generate transaction data, the transaction data contains a unique identifier of the first institution, to enable a UTXO transaction data chain (a TXO transaction data chain) generated by the first institution to be logically isolated from a UTXO transaction data chain (a TXO transaction data chain) generated by another institution.

Blockchain ledger data generated by the first institution includes block header and block body data, wherein the block header data includes fingerprint information of the block body data, the block body data contains a collection of transaction data, and the UTXO transaction data chain is formed by referencing an unspent transaction output between the transaction data.

Act 22, merging the UTXO transaction data chain (TXO transaction data chain) generated by the first institution (the first subject) and a UTXO transaction data chain (a TXO transaction data chain) generated by another member institution (another member subject) belonging to a same consortium blockchain as the first institution to form a UTXO transaction data chain (a TXO transaction data chain) of the consortium blockchain.

By using the transaction data processing method of the embodiment of the present disclosure, a UTXO transaction data chain generated by each institution is logically isolated by using a unique identifier of an institution in an address, and merging of ledgers of different private blockchains (permission chains) or sub-private blockchains (sub-permission chains) that are logically isolated may be achieved.

Merging ledger data of a plurality of permission chains into ledger data of the consortium blockchain, includes: generating a first layer of ledger data of the consortium blockchain after block header data of the plurality of permission chains are of consensus, and transaction data corresponding to block header data of a permission chain is used as a second layer of ledger data of the consortium blockchain, which is essentially to merge Transaction Output (TXO) transaction data chains of the plurality of permission chains into a TXO transaction data chain of the consortium blockchain. A TXO transaction data chain is generated according to a UTXO model, and may also be called a UTXO transaction data chain.

A transaction of the UTXO model may contain one or more inputs and one or more outputs, each input is to reference to a forward unspent transaction output and become spent, and to create one or more new unspent transaction outputs. Herein, a reference connection may be categorized into an explicit connection and an implicit connection. Unlocking script needs to be associated with corresponding locking script, and others can know that a referenced unspent output, which is an explicit connection mode, such as “txid+index” or primary address, wherein txid represents a transaction ID of the unspent output referenced by the input, and index represents a serial number. A collection of expense vouchers records fingerprints of all spent outputs, so it can't be spent repeatedly. Others don't know a referenced unspent output, which is an implicit connection mode, such as zero-knowledge proof or a ring secret transaction.

The above may be regarded as spending one or more outputs (spent) and creating one or more new outputs (unspent), which constantly and circularly extends backward, all Spent Transaction Outputs (STXOs) and UTXOs can form a Directed Acyclic Graph (DAG) structure, regardless of whether a connection between them is explicit or implicit. And this DAG structure reflects a process of token circulation, so it is called a transaction data chain of the DAG structure (or a TXO transaction data chain).

An explicit connection between locking and unlocking indicates that it is a connection on a transaction chain, whether a reference connection is txid+index or primary address, as long as an output can be effectively referenced and whether it is unspent can be determined. Although an implicit connection using an expense voucher does not indicate which connection on a transaction chain is used, it cannot be double-spent through the expense voucher, indicating that it is one of connections and has not been spent before. So the implicit connection is a transaction chain with a DAG structure even if it is not indicated, it is just a connection in which a chain is hidden (a sender knows a referenced unspent output while others do not know).

A manner of an explicit primary address connection is used for a DAG structure of a consortium blockchain, because each address may contain a unique identifier of a chain (i.e., a chain ID) as a prefix, and the address is unique in a private blockchain, so transaction data can be logically isolated and has a globally unique connection address, so transactions merged into the consortium blockchain will not conflict. If transaction data of the private blockchain is merged directly, only a manner of an explicit primary address connection may be used. However, transaction data of each private blockchain is independently verified and put on-chain on the consortium blockchain, and a first layer in the consortium blockchain only has block header data of a private blockchain, so an internal connection of a sub-DAG structure of the private blockchain may be replaced by another manner, including txid+index or an implicit connection or another manner, but a cross-private blockchain transaction still needs to keep a way of a primary address. Therefore, transaction data of UTXO models of private blockchains with different technical methods may be merged into a ledger of the consortium blockchain.

Therefore, a transaction of a UTXO model in any way may be abstracted as a transaction chain with a DAG structure, and the DAG structure is also a theoretical basis for mergeability. Because the DAG structure can be split into multiple sub-DAG structures, and multiple sub-DAG structures may also be merged into one DAG structure. A transaction of a UTXO model of the consortium blockchain can form a transaction chain of a DAG structure (by means of an explicit primary address connection), and then may be split into multiple sub-DAGs, each sub-DAG is formed by a transaction of a UTXO model of one private blockchain, so transactions of UTXO models of multiple private blockchains may be merged into a ledger of the consortium blockchain. And merging DAG structures is essentially a circulation process of merging tokens. In an exemplary embodiment, ledger data of the consortium blockchain may be generated by means of merging private blockchain ledger data of the first institution and private blockchain ledger data of another member institution of the consortium blockchain. The UTXO transaction data chain is formed by transaction data, so merging transaction data of ledgers may be achieved by merging ledger data, thereby achieving merging of UTXO transaction data chains that are formed by transaction data and are logically isolated.

In an exemplary embodiment, private blockchain ledger data of the first institution and private blockchain ledger data of another institution of the consortium blockchain are merged to generate ledger data of the consortium blockchain, including: transaction data contained in block body data in private blockchain ledger data of the first institution is verified as passed by another member institution, private blockchain block header data corresponding to the block body data is verified as passed and signed by another member institution, and the private blockchain block header data contains a unique identifier of an institution. The private blockchain block header data of the first institution that has been verified as passed and the private blockchain block header data of another member institution that has been verified as passed are merged and are of consensus, and merged private blockchain block header data is used as block body data of the consortium blockchain.

The above explains that DAG structures (TXO transaction data chains) formed by circulation processes of transaction data of UTXO models of permission chain ledgers of different subjects may be merged, so ledgers of transaction data may be merged, but the subjects do not share a ledger with each other, so a bookkeeping process without transaction data is needed.

In an exemplary embodiment, through endorsement and signature by a verifier, a bookkeeping process, which may be without transaction data, of a bookkeeper is as follows: the verifier verifies transaction data to be logically put on-chain, corresponding fingerprint information is generated according to the transaction data after being verified as passed, and a block header hash value for indicating a restricted block position is added, the restricted block position is at least a maximum block position corresponding to an unspent transaction output on a blockchain referenced by the transaction. The restricted block position (or referred to as a restricted block height) indicates that fingerprint information of the transaction must be at the block position (or after the height) before it can be put on-chain, and then the verifier endorses and signs relevant information to be put on-chain. The bookkeeper verifies that multiple verifiers endorse and sign same information (including a fingerprint and a restricted block position, etc.) to be put on-chain, and if a quantity of verifiers exceeds a preset number (for example, more than ⅔), the information to be put on-chain may be consensus-put on-chain, and a requirement of the restricted block position should be met after being put on-chain. Since transaction data is a UTXO model, after the transaction data of the UTXO model is verified to be correct, it is correct as long as a position of being put on-chain is after a referenced transaction that is input, and since a restricted position is a hash value of a block header, even if blockchain bifurcation causes some blocks to be invalid, whether the restricted block position is valid or not may be determined according to the hash value of the block header, if it is invalid, it cannot be put on-chain, ensuring that a logical ledger without transaction data is correct. If it is a transaction data set, fingerprint information of the transaction data set and a block header hash value of a maximum restricted block position corresponding to all transaction data in the transaction data set are generated. And when information, verified as passed, to be put on-chain can be put on-chain is determined by the bookkeeper's consensus, and an unspent output corresponding to the data can be referenced after being put on-chain, so being verified as passed by a verifier is only a necessary and insufficient condition for being put on-chain.

The verifier verifies transaction data in a trusted execution environment (for example, in an isolated environment within a subject corresponding to a blockchain, transaction data is not out of the subject), only information to be put on-chain with endorsement and signature is returned, and then is consensus-put on-chain by a bookkeeper, thus achieving a bookkeeping process without transaction data. Therefore, information that appears outside the subject is only a fingerprint of transaction data (set), and private data will not be leaked. A privacy method such as a ring secret transaction may also be adopted for transaction data, and a subject may choose public data for verification. A difference is that the subject may know privacy of a transaction, while others can only verify the transaction data and do not know the privacy.

In an exemplary embodiment, before the merging the TXO transaction data chain generated by the first subject and the TXO transaction data chain generated by another member subject belonging to the same consortium blockchain as the first subject, i.e., before block data of a subject is logically put on-chain on the consortium blockchain, the method further includes: a verifier verifies permission chain block data (the block data that is verified is block data corresponding to permission chain block header data to be put on-chain, which may be called permission chain block data to be logically put on-chain), after being verified as passed, a block header hash value indicating a restricted block position is added in the permission chain block header data to be put on-chain (including fingerprint information of block transaction data), wherein the restricted consortium blockchain block position is at least a maximum block position corresponding to an unspent output on the consortium blockchain referenced by a cross-permission chain transaction in the permission chain block, and the permission chain block header data added with the block header hash value for indicating the restricted consortium blockchain block position is endorsed and signed. Since a permission chain block data of a subject is a collection of transaction data, characteristics of a UTXO model only need a maximum restricted block position of transaction data. Transaction data contained in a permission chain of the subject may be categorized into an intra-blockchain transaction (an input references an unspent output of a transaction within the subject) and a cross-chain transaction (an input references an unspent output of a transaction of another subject), while the intra-blockchain transaction may contain a dependent forward unspent output by default through sequential putting on-chain of permission chain block headers, so the added restricted block position only needs a maximum restricted block position of the cross-chain transaction.

In this embodiment, verification executed by a verifier of a consortium blockchain is executed before ledger data of the consortium blockchain is merged. After being verified as passed, transaction data of a plurality of permission chains belonging to a same consortium blockchain are merged into ledger data of the consortium blockchain, for example, by means of merging block header data of permission chains. In this embodiment, the verification executed by the verifier of the consortium blockchain is verification for a permission chain block to be put on-chain.

Inside a consortium, only a token issued by the consortium is verified, and verification of another token in a private blockchain is not performed, so merging into a ledger of a consortium blockchain is equivalent to only merging circulation of tokens issued by the consortium.

Therefore, even if tokens issued by different consortiums are circulated in a certain private blockchain, the consortium only verifies circulation of tokens of a present consortium, which is equivalent to different DAG structures, so tokens of two or more consortiums may be circulated inside a system and it may participate in merging of multiple consortium blockchains without conflict. After a private blockchain meets a condition, it may also choose to join or leave the consortium blockchain. For example, if there is no unspent output of circulating a consortium token in the system, it may leave the consortium blockchain.

An embodiment of the present disclosure also provides a manner of achieving correct bookkeeping of fingerprint information (such as block header data) of transaction data (set) through a block header hash value of a restricted block position. A bookkeeper consensus-generates a logical ledger (such as a consortium blockchain), and the ledger only logically contains transaction data. That is, the consortium blockchain has a two-layer structure, a first layer only contains fingerprint information or a block header of a transaction data set, a second layer is transaction data pointed by the first layer, that is, logically contains transaction data, and a UTXO transaction data chain of the consortium blockchain is composed of the transaction data of the second layer logically contained.

In an exemplary embodiment, after being verified as passed, a block header hash value for indicating a restricted consortium blockchain block height is added to block header data of a permission chain to be put on-chain, wherein the restricted consortium blockchain block height is a restricted consortium blockchain block position, which is at least a maximum block height corresponding to an unspent output on a consortium blockchain referenced by a cross-permission chain transaction in a permission chain block; in an exemplary embodiment, the restricted consortium blockchain block height may be greater than the maximum block height, for example: a block header hash value for indicating a restricted consortium blockchain block height is contained in a previous permission chain block and the restricted consortium blockchain block height is greater than the aforementioned maximum block height (taking a larger value of the two).

Through the restricted consortium blockchain block position, it is limited that a block put on-chain on the consortium blockchain can only be behind the restricted consortium blockchain block position, so as to ensure that cross-chain transactions all reference a forward unspent output on the consortium blockchain. And a hash value of a consortium blockchain block header at a corresponding position is added, so even if the consortium blockchain bifurcates before the position, a forward block header without a same hash value can be determined, so the permission chain block header cannot be consensus-put on-chain on the consortium blockchain; if bifurcation occurs after the position, the forward block header with the same hash value can be determined, so the permission chain block header can be consensus-put on-chain on the consortium blockchain.

In an exemplary embodiment, the addition of the block header hash value for indicating the restricted consortium blockchain block position to the permission chain block header data to be put on-chain may be in a following manner: when the permission chain block to be put on-chain does not contain a cross-permission chain transaction, recursively forwarding to a previous permission chain block containing a cross-permission chain transaction on the permission chain, finding a permission chain block header pointing to the permission chain block on a consortium blockchain, and adding a block header hash value for indicating a restricted consortium blockchain block height in the permission chain block header to permission chain block header data to be put on-chain at present (an explicit restricted height mode); or when the permission chain block to be put on-chain does not contain a cross-permission chain transaction and recursively forwarding to a permission chain block containing a cross-permission chain transaction on the permission chain (i.e., as long as there is a permission chain block containing a cross-permission chain transaction), adding a second preset value (e.g., FF . . . FF) to the permission chain block header data to be put on-chain at present (an implicitly restricted height mode).

In an exemplary implementation mode, a block header hash value used for indicating the restricted consortium blockchain block position in the permission chain block header data to be put on-chain is set to a first preset value (e.g., zero) when recursively forwarding to an originating block, which still does not contain a cross-permission chain transaction, on the permission chain.

In an exemplary embodiment, a verifier of the consortium blockchain endorses and signs permission chain block header data added with a block header hash value for indicating the restricted consortium blockchain block height.

In a process of merging ledger data of the consortium blockchain, a bookkeeper of the consortium blockchain carries out consensus on permission chain block header data endorsed and signed by a plurality of verifiers of the consortium blockchain to generate a first layer of ledger data of the consortium blockchain, and UTXO model transaction data corresponding to a permission chain block header is a second layer of ledger data constituting the consortium blockchain. Therefore, permission chain block header data put on-chain on the consortium blockchain all contains a block header hash value indicating a restricted consortium blockchain block position. Since a maximum block height corresponding to an unspent output on the consortium blockchain referenced by a cross-permission chain transaction in a permission chain block is certain, block header hash values added by different verifiers indicating a restricted consortium blockchain block position are the same.

A bookkeeper of the consortium blockchain is required to ensure that a block header hash value indicating a restricted consortium blockchain block position corresponding to a permission chain block header put on-chain on the consortium blockchain is equal to a certain forward consortium blockchain block header hash value, and if the hash value is the first preset value or the second preset value, a block height put on-chain on the consortium blockchain is not restricted. If a permission chain block header contains the first preset value, it may be used as a first block header data put on-chain on the consortium blockchain, and the first block header data of the permission chain put on-chain on the consortium blockchain is required to contain the first preset value; if the permission chain block header contains the second preset value, it means that a previous block in the permission chain contains a cross-permission chain transaction and cannot be used as the first block header data put on-chain on the consortium blockchain, and a block height put on-chain on the consortium blockchain is implicitly restricted in combination with a mode of sequentially being put on-chain on the consortium blockchain. The permission chain block header containing the second preset value must be put on-chain on the consortium blockchain after a block height put on-chain on the consortium blockchain which is explicitly restricted.

In an exemplary embodiment, the generating the first layer of ledger data of the consortium blockchain after carrying out consensus on the plurality of permission chain block header data which are endorsed and signed includes: a bookkeeper consensus-puts on-chain information to be put on-chain which meets a condition and is generated by a verifier, and the condition includes, but is not limited to: being verified as passed by more than a preset quantity of verifiers (for example, more than ⅔ of the verifiers), a requirement for a restricted block position is met, and being endorsed and signed by the verifier; wherein the requirement for the restricted block position is met, including: a block header hash value (when not equal to a preset value) indicating a restricted consortium blockchain block position corresponding to a permission chain block header to be put on-chain on the consortium blockchain is equal to one of forward consortium blockchain block header hash values; permission chain block headers are sequentially put on-chain on the consortium blockchain (other permission chain block header data may be contained in between, and an order of block headers of a same permission chain is not disrupted), and a first block header data of the permission chain put on-chain on the consortium blockchain is required to contain the first preset value. The requirement for the restricted block position is met, which can satisfy that each transaction related to a consortium token has correct forward unspent output referenced by an input after being put on-chain on the consortium blockchain.

In an exemplary embodiment, a verifier synchronizes a logical ledger generated by a bookkeeper, and an output of a corresponding transaction may be referenced by an input only after fingerprint information of relevant transaction data is put on-chain, and the output of the transaction has a block header hash value of a restricted block position, i.e., a hash value of a corresponding logical ledger block header, i.e., a block header hash value of a corresponding restricted block position when the transaction is referenced by the input.

Detailed explanations are given below.

An Unspent Transaction Output (UTXO) model is used for transaction data of a consortium blockchain or a private blockchain of an embodiment of the present disclosure A transaction of the model contains one or more inputs and one or more outputs, each input includes a reference to a forward unspent transaction output and a corresponding unlocking script. When the reference to the forward unspent transaction output is unlocked, the reference cannot be unlocked again, that is, it cannot be double-spent. Each output contains a corresponding token amount and a locking script, and the locking script requires a corresponding unlocking script to be unlocked, that is, a new unspent transaction output is created. Therefore, one transaction data may contain multiple input unlocking scripts and multiple output locking scripts.

Each output of transaction data of a solution of an embodiment of the present disclosure may contain a globally unique address, and an input references the unique address, so the transaction data is connected by means of the unique address. Each transaction data references forward one or more unspent outputs to become spent, and one or more new unspent transaction outputs are created, which constantly and circularly extends backward. Since each connection is a unique address, a Directed Acyclic Graph (DAG) structure will be formed, that is, a TXO transaction data chain, which is also called a UTXO chain in the following.

In this solution, a reason why each institution can generate ledger data without conflict with another institution and the ledger data generated by each institution can be merged is that characteristics of the unique address is used. By including a unique institution identifier (ID) of an institution in an address, an address of ledger data generated by each institution is logically isolated, that is, a UTXO chain generated by each institution is isolated, so ledger data may be directly merged without any conflict, but a cross-chain transaction needs isolated logical chains to be connected with each other, so a relevant transaction mode is needed.

An embodiment of the present disclosure may use a transaction mode of a commitment address, namely, one transaction of a user is split into two transactions which are a transaction between a sender and an institution and a transaction between the institution and a receiver, or is split into three transactions which are a transaction between a sender and an institution A, a transaction between the institution A and an institution B, and a transaction between the institution B and a receiver, which is equivalent to crossing a private blockchain A and a private blockchain B; if it crosses multiple private blockchains, that is, multiple institutions, it is split into more transactions.

For example, if a transaction is within an institution, it may include an intermediate transaction between a sender and an institution and an obfuscated transaction 1 between the institution and a receiver; if it is a cross-chain transaction, it may include an intermediate transaction between the sender and an institution A, an obfuscated transaction 2 between the institution A and an institution B, and an obfuscated transaction 1 between the institution B and a receiver, wherein a plurality of obfuscated transactions 2 may be added (an input of an added obfuscated transaction 2 is a cross-chain transaction address output by a previous obfuscated transaction 2), that is, the transaction may cross a plurality of chains (institutions).

The above intermediate transaction is generated by a user (a sender), an input references a user address of an unspent transaction output, which contains an unlocking script, an output is an intermediate transaction address, and a commitment address set of a receiving user; an obfuscated transaction is generated by an institution, an input references output addresses of a plurality of intermediate transactions (or a cross-chain transaction address output by the obfuscated transaction 2), an output includes a cross-chain transaction address of a second institution, an output commitment address of a second user, and includes a plurality of locking scripts, and a locking script corresponds to a user address of a receiver and is associated through the output commitment address.

Amounts of an intermediate transaction and an obfuscated transaction may all be kept secret by means of homomorphic encryption, such as Pedersen Commitment, and a committed amount may be proved to be within a certain range through Range Proof to avoid a negative number or overflow. Therefore, privacy of user data may be protected through address commitment and homomorphic encryption, and others may verify a transaction.

The above-mentioned obfuscated transaction 2 is similar to the obfuscated transaction 1, a difference includes that an output of the obfuscated transaction 2 is a cross-chain transaction address, and through this address, it is equivalent to identifying a behavior of cross-chain, so that UTXO chains which are logically isolated between institutions are connected with each other. A contract contained in a transaction can only be decrypted and viewed by a relevant user and institution, and other institutions and users cannot decrypt it and therefore cannot verify it. Those that can be publicly verified include, but are not limited to, one or more of following: verifying whether an address rule of a transaction is correct (e.g., whether an input reference address and an output address contain an identifier of an institution to be verified, and/or whether a cross-chain transaction address contains an identifier of a receiving institution); verifying whether e transaction data is correct (including but not limited to one or more of following: whether a referenced unspent transaction output exists, whether there is double expenditure, whether a transaction amount of Pedersen Commitment (homomorphic encryption) is correct, whether an unlocking script is valid, whether a commitment address is correct, etc.); verifying whether a cross-chain transaction address referenced by an input is an unspent transaction output put on-chain on the consortium blockchain, and verifying whether a non-cross-chain transaction address referenced by the input is an unspent transaction output to be put on-chain on the consortium blockchain or an unspent transaction output put on-chain on the consortium blockchain. Since whether a contract is correct only needs to be verified by a relevant user, and other users or institutions don't need to care about it, ledgers can be merged directly after verifying that a UTXO chain is correct and conforms to a rule, that is, logically isolated UTXO chains are merged.

An address involved in private blockchain transaction data of an institution includes, but is not limited to, one or more of following addresses: an issuing address, a recycling address, a user address, an intermediate transaction address, and a cross-chain transaction address, etc. Different types of addresses may have different lengths, but all contain a unique institution ID corresponding to the institution.

Formats of the issuing address and the recycling address may be, for example, “address type+institution ID+unique serial number”, such as an issuing address A2300001, wherein A is an issuing address type, 23 is an institution ID, and 00001 is a unique serial number of a token issued by the institution. Through the serial number, it is convenient to find all issuing or recycling transactions of a corresponding institution. An amount of tokens issued or recycled is in plain text, but only a total amount of tokens of all institutions in the consortium blockchain can be known, because an amount of tokens of a cross-chain transaction is not public. That is to say, a total number of tokens in the consortium blockchain is public and deterministic, but a total number of tokens in a private blockchain is indeterminate.

For example, a format of a user address may be “address type+institution ID+transaction mode (optional)+primary address”, and the primary address is an address generated by a user's primary public key. For example, after the primary public key is derived from a user's signature public key, an address obtained by hash operation is the primary address, for example: primary address Lb=HL(Qb), wherein Qb is the user's primary public key, which may be called a public key corresponding to the primary address, Qb=kb*Pb, Pb is the user's signature public key, kb is an intermediate value, and HL is an address hash function. Taking a case that the user address is 12317466924e4f854afd8e494fa657a4 as an example, wherein 1 is a user address type, 23 is an institution ID, 1 is a commitment address transaction mode, and the rest is a primary address. The primary address is required to correspond to a user's primary public key, and an unlocking script of a reference address needs to give a primary public key or commitment address operation (that is, a commitment address is associated with a user's primary public key) to obtain the primary address, and it is necessary to use a private key corresponding to the primary public key to sign and complete an unlocking process. In this example, a unique user address is output through an obfuscated transaction generated by an institution, that is, the user's primary address needs to be guaranteed to be unique within the institution. However, in order to avoid that a same user primary address is generated by different institutions and a corresponding primary public key and private key are also the same, a HL address hash function may be added with an institution ID, that is, Lb=HL(ID, Qb), so that even if different institutions generate a same user primary address Lb, a corresponding primary public key Qb and private key are different, thus different institutions cannot unlock an output of each other's same user primary address.

A format of an intermediate transaction address may be, for example, “address type+institution ID+transaction mode (optional)+unique number”, such as 42317466924e4f854afd8e494fa657a4, wherein 4 is an intermediate transaction address type, 23 is an institution ID, 1 is a commitment address transaction mode, and the rest is a unique number. The unique number may be a random number, which only needs to be guaranteed to be unique (at least within an institution). Optionally, a referenced primary address may be used as the intermediate transaction address, and an address type may be replaced to obtain a unique intermediate transaction address, that is, an output address of each transaction in a private blockchain is guaranteed to be unique. The intermediate transaction address is a special address of the institution, which may be unlocked only by a signature of a corresponding institution, and may be output to a user address associated with a commitment address.

A format of a cross-chain transaction address may be, for example, “address type+institution ID+cross-chain institution ID+transaction mode (optional)+unique number”, such as 623241c402262890e3, wherein 6 is a cross-chain transaction address type, 23 is a current institution ID (an institution that generated an unspent transaction), 24 is a cross-chain institution ID, 1 is a commitment address transaction mode, and the rest is a unique number. This address can indicate that corresponding transaction data is generated by an institution 23 and one of outputs therein is the address, which can only be referenced by a transaction generated by an institution 24 and can only be referenced once, which requires only a signature of a corresponding institution (in this example, the institution 24) to complete unlocking, and may be output to a user address associated with a commitment address. An amount of Pedersen Commitment corresponding to this output may be secretly informed to the institution 24 by the institution 23, so the institution 24 may know an amount committed in plain text. In this cross-chain transaction mode, a transaction generated by the institution 23 cannot reference the address, and the address may only be referenced by a transaction input generated by the institution 24 and only be referenced once, so as to ensure that both parties will not generate a conflicting transaction, and at the same time, a corresponding token amount is transferred from the institution 23 to the institution 24, and another institution may verify that the transaction is correct but do not know an amount committed in plain text.

In an exemplary embodiment, a format of a cross-chain transaction address may be, for example, “address type+institution ID+cross-chain institution ID+restricted cross-chain block height+transaction mode (optional)+unique number”, such as 623241e1c402262890e3, which is different from the cross-chain transaction address in a previous example in that a restricted cross-chain block height is added, which in this example is 1e (for another example, it may be 00) and may be hexadecimal. The restricted cross-chain block height may be used in two ways. First, if the restricted cross-chain block height is a first preset value (e.g., 0), it means that the address cannot be referenced by a transaction generated by an institution 23, and can only be referenced by a transaction input generated by an institution 24 and can only be referenced once meanwhile, so as to ensure that both parties will not generate a conflicting transaction, that is, neither the institution 23 nor another institution can reference the address. Second, if the restricted cross-chain block height is not the first preset value, such as 1e (i.e., m=30), after a second transaction generated by a current institution is put on-chain, it is referenced by the cross-chain institution within the restricted cross-chain block height, or referenced by the current institution after the restricted cross-chain block height. For example, if the transaction is put on-chain when a consortium blockchain block height is n, that is, the consortium blockchain block height n contains transaction data, a transaction referenced by the institution 24 must be put on-chain before the consortium blockchain block height is n+m, otherwise it can only be referenced by the institution 23 after n+m, that is, it is required to complete cross-chain before the consortium blockchain height is n+m, otherwise it cannot cross-chain and can only be referenced by the institution 23 (non-cross-chain). It is equivalent to limiting an opportunity for the institution 24 to reference the cross-chain transaction, that is, the cross-chain transaction is completed within a window range of m blocks starting from an n-th block, that is to say, only the institution 24 can reference before an (n+m)-th block and only the institution 23 can reference after the (n+m)-th block, in short, the transaction can only be referenced by the institution 23 or the institution 24 once.

Intercommunication of logically isolated private blockchains may be achieved through a cross-chain transaction address, and the address can only be referenced by a transaction generated by a corresponding cross-chain institution and can only be referenced once, so a cross-chain transaction can be achieved definitely and without conflict, and ledger data can be merged (a connection between logically isolated UTXO chains).

In the above examples, values in an address format are examples only and other values may be used in other embodiments.

In the above examples, a requirement for the address format is only an example, and in other embodiments, there may be corresponding changes, including but not limited to, adding information or reducing information, such as reducing transaction mode information.

In an exemplary embodiment, if there are other addresses, they may also be generated in the above way or in a similar way, to ensure that UTXO chains formed by private blockchain transaction data generated by an institution will not collide so that merging may be performed.

An address within each institution is guaranteed to be unique by an institution itself. User data of each institution is encrypted and protected by the institution itself. For example, a commitment amount output by the above cross-chain transaction may be informed by the institution 23 to the institution 24, otherwise the institution 24 will not know. At the same time, an obfuscated transaction 1 or 2 is generated by an institution, and a commitment amount output is also generated by the institution, so only the institution and a corresponding user are aware of it. Moreover, each institution can only process data of a user managed by this institution, an output cannot contain an address that does not contain its own institution ID, and an input can reference only a cross-chain transaction address and a cross-chain institution ID in the address specifies itself, in addition to an address that contains its own institution ID.

Therefore, a plurality of institutions may verify each other whether generated private blockchain ledger data is correct, and it is ensured that transaction data will not conflict through the aforementioned address generation method (an address output in a transaction is a newly generated unique address, and each address contains an institution ID) and an address reference method (referencing an address may only be referencing an address of a present institution ID, or the present institution ID is indicated in a referenced cross-chain transaction address, or the present institution ID is indicated in the referenced cross-chain transaction address and before a prescribed restricted cross-chain block height), so that private blockchain ledger data can be directly merged into consortium blockchain ledger data, that is, UTXO chains formed by the transaction data are merged into a larger UTXO chain.

By including a unique institution ID of each institution in an address (including an offline transaction address), and using the address containing the institution unique ID to participate in a transaction (referencing an address of its own ID or referencing an address indicating its own ID in a cross-chain transaction address), transaction data generated by an institution is logically isolated, so that a private blockchain of the institution may be verified to be correct and then merged. A transaction data output address contained by a private blockchain of an institution includes an address containing the institution ID, an input reference address includes the address containing the institution ID, or is a cross-chain transaction address and a cross-chain institution ID in the cross-chain transaction address is the institution ID. Therefore, each institution can generate a UTXO chain that is logically isolated and ledgers can be directly merged.

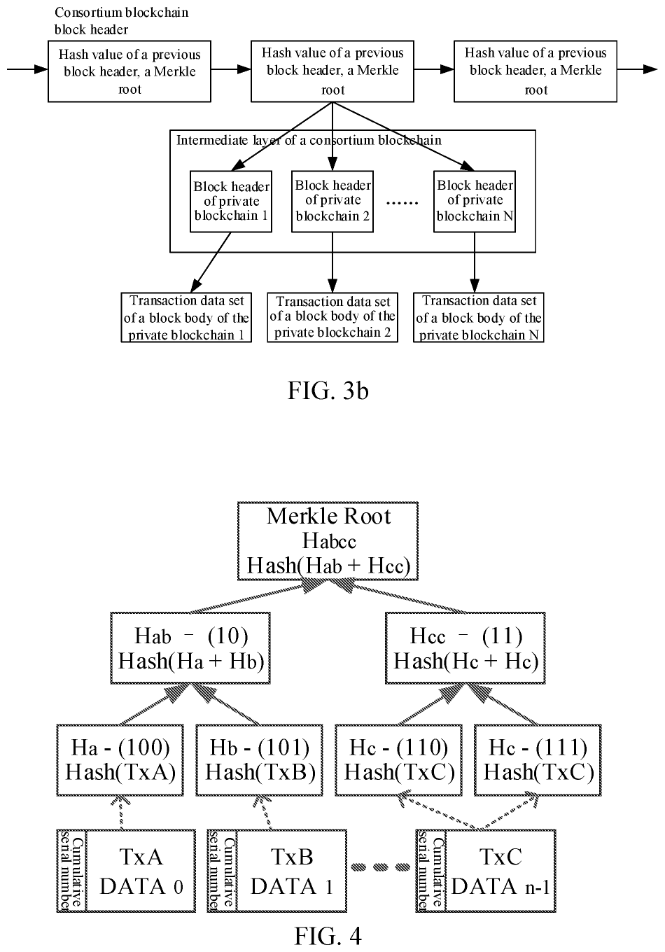

Block data of a private blockchain or a consortium blockchain (ledger data is block data connected sequentially) includes a block header and a block body, wherein the block body contains an affair data set, the block header data contains a fingerprint of a previous block header data (a hash value of a block header) and a fingerprint of corresponding block body data (a hash value of a Merkle tree root), and existence of affair data of a block body can be verified through a block header (a member proof). After a private blockchain of each institution is verified as passed, direct merging of the private blockchain of each institution may be direct merging and packaging of transaction data in a block body, and then a consortium blockchain block header is consensus-generated (mode 1); or may be that consortium blockchain block body data is consensus-generated through private blockchain block header data of each institution, that is, a generated block body contains a block header set of the private blockchain, and the consortium blockchain block body data may sequentially contain block header data of the private blockchain in turn. This mode is equivalent to that a block body of the consortium blockchain is an intermediate layer, that is, a private blockchain block header is used as intermediate layer data, pointing to under-chain private blockchain block body ledger data, and the private blockchain block body ledger data is an under-chain transaction data ledger of the consortium blockchain (mode 2, that is, logical inclusion, this mode is used for the consortium blockchain herein, and the mode 2 is based on the mode 1), as shown in FIGS. 3a and 3b, and a structure of consortium blockchain block data is shown in FIG. 3a, and one example is shown in FIG. 3b.

After a private blockchain of each institution is verified as passed, consensus is performed on block header data of the private blockchain to obtain block data of a consortium blockchain, and the block data of the consortium blockchain sequentially ocntains the block header data of the private blockchain. The consortium blockchain has a private blockchain block header as intermediate layer data, and what it points to (a private blockchain block body) is an under-chain transaction data ledger of the consortium blockchain. The block header of the private blockchain contains a corresponding institution ID and a quantity of transactions and is signed by an institution. A block header of the consortium blockchain contains a quantity of private blockchain block headers in a block body and is jointly signed by multiple institutions. Therefore, similarly, intermediate layer data (private blockchain block header) of multiple consortium blockchains may be merged to become a larger consortium blockchain data.

An institution may generate a private blockchain by itself, and may not participate in a consortium blockchain if a cross-chain transaction is not needed. If the cross-chain transaction is needed, it may join the consortium blockchain without making any change. Another institution may join the consortium blockchain after a private blockchain is verified. However, when joining a large amount of ledger data of a private blockchain may be needed to contain, so it is more beneficial to control a size of the consortium blockchain by using a merging mode of block headers (the above mode 2, that is, logical inclusion). Since private blockchain ledger data of each institution is a UTXO chain, large-scale ledger data may be stored in a distributed way using connected storage through a Distributed Hash Table (DHT) and verified. Therefore, that is, a private blockchain of each institution may be stored and verified by means of a DHT, which can verify whether the private blockchain ledger data of each institution is correct. If being verified to be correct, consortium blockchain block data is consensus-generated through block header data of the private blockchain. Since each private blockchain data is a UTXO chain with a backward and forward dependency relationship, block header data of a private blockchain which is packed must also be included sequentially. If being verified to be wrong, the consortium blockchain cannot be joined later. If there is no cross-chain transaction, even if no consortium blockchain block data is consensus-generated, a private blockchain generated by an institution will not affect another institution adversely, so a consensus algorithm with high concurrency and short delay may be used for generating the private blockchain within the institution; if there is a cross-chain transaction, another institution can reference a cross-chain transaction address only after the generated private blockchain is verified as passed and consortium blockchain block data is consensus-generated. Therefore, a consensus algorithm with relatively long delay may be used for the consortium blockchain, all that is affected is only transaction completion time of a cross-chain transaction address referenced by an input.

A reason for the above consensus-generating the consortium blockchain through the private blockchain block header is that even if all transaction data in a private blockchain block are packed to generate ledger data of the consortium blockchain, it is deterministic and conflict-free, and a logically isolated UTXO chain of each institution is merged into a larger UTXO chain, so its significance is not only to simply pack block header data, but to pack transaction data generated by each institution together into a larger UTXO chain, so generated consortium blockchain block body data may only be an intermediate layer, and the consortium blockchain block body data points to under-chain private blockchain block body ledger data. Therefore, transaction data generated by all institutions may be placed in one DHT and verified through a block header of the consortium blockchain. A (consortium blockchain) member proof of each transaction data contains two verification paths and block header data of one private blockchain (the member proof is to verify whether a data is data contained in a block body through a block header), for example including verifying transaction data through a first Merkle Root in the private blockchain block header and verifying block header data of the private blockchain through a second Merkle Root in a consortium blockchain block header. That is, there are two layers of member proofs, it is proved that a transaction is contained in a private blockchain block through a first layer of member proof, and it is proved that the private blockchain block header is contained in a consortium blockchain block through a second layer of member proof, so it is finally proved that the transaction is contained in the consortium blockchain block. Therefore, this merging mode is actually to merge transaction data of the private blockchain into a larger UTXO chain, only using block header data of the private blockchain as an intermediate layer. Although private blockchain ledger data may be publicly verified without revealing privacy, an institution may also use a Trusted Execution Environment (TEE) to isolate and verify the ledger data, because institutions only need to verify each other's ledgers and then consensus-generate the consortium blockchain through the private blockchain block header, and do not necessarily need to obtain the ledger data of the private blockchain. However, in a cross-chain transaction, for example, an institution B references a cross-chain transaction address in a transaction T of an institution A, the institution A needs to send the transaction T and a corresponding consortium blockchain member proof to the institution B for verification, and the transaction data is also confidential, and the institution A only informs the institution B of a corresponding commitment amount in plain text.

Therefore, private blockchain ledger data of an institution may be fully protected at multiple levels under control of the institution itself, and corresponding transaction data needs to be presented only during a cross-chain transaction. Therefore, it is beneficial for mutual participation of institutions that do not need trust.

A Merkle Tree is a binary tree, a leaf node at a bottom is a hash value of Data, and an intermediate node corresponds to a hash value obtained from an operation of two child nodes. If a right child node does not exist, a value of a left child node is copied, and so on, and finally a hash value of a top root node is generated. It may be seen that if a quantity and positions of leaf nodes at the bottom are known, a path from each leaf node to the root node is fixed, that is, a bit length and parity of a path serial number are fixed. A verification path of a leaf node is from the leaf node to a sibling node on a path to the root node, so the Merkle Tree may be used for verifying the leaf node and its corresponding position. That is to say, when a quantity and position of Data in a block body are known, a depth and direction of a verification path corresponding to Data are fixed and known, which cannot be replaced by different paths, and a serial number corresponding to a path may be added before path data when a hash value is calculated. For example, a block contains n>0 Data with a depth d=ceil (log 2 n) and d>0, so a path serial number of Hash(Data 0) is 2^{A}d, and a path serial number of Hash(Data i) is i+(2\hat{ }d). When calculating a hash value of Data of a leaf node, the path serial number i+(2\hat{ }d) of Data may be contained, and when calculating a hash value of an intermediate node, a path serial number corresponding to the node may be contained. For each operation, a serial number corresponding to an upper layer is divided by 2 (as shown in FIG. 4, a binary number serial number is shifted to the right by 1), and parity of the serial number indicates right and left directions of a current path until the serial number is equal to 1, that is, a Merkle Root is obtained. Therefore, a binary number of a path serial number of data also indicates a height of a path. A serial number of a verification path is xor of a current path serial number and 1, and a generated block header contains a quantity n of Data, and a corresponding cumulative incremental serial number may be added before Data data. Since block headers are connected sequentially, a cumulative increment serial number of Data 0 in a current block is a sum of quantities n in all previous block headers. So whether a serial number (that is, the position) of data Data is correct may be verified through a Merkle Tree. In an embodiment of the present disclosure, by setting each path of a Merkle Tree to have a corresponding serial number and each data Data to have a unique serial number, and a path serial number and length corresponding to the data Data are known, so the serial number of the data Data and whether a path and a path serial number are correct may be verified in combination with an accumulated number in a block header. An example of a Merkle tree containing serial numbers is shown in FIGS. 4, 10, 11, 100, 101, 110 and 111 in the figure are path serial numbers of binary numbers, the path serial numbers may be calculated and obtained through a verified data position (serial number), so that it is possible to achieve a member proof of data and verify whether a data position is correct.

For an institution joining the consortium blockchain, a transaction in private blockchain block data is verified by another institution, including that a cross-chain transaction address referenced by an input is an unspent transaction output put on-chain on the consortium blockchain (i.e., which has a member proof of the consortium blockchain), and a non-cross-chain transaction address referenced by the input is an unspent transaction output of a private blockchain to be put on-chain on the consortium blockchain (which has only a member proof of the private blockchain) or an unspent transaction output put on-chain on the consortium blockchain. If all transactions related to a consortium token in a block are verified successfully, a verification institution signs a block header, and verification and signature processes may be executed in isolation in a Trusted Execution Environment (TEE), and only a block header marked as valid and signed may be returned. When it is verified as passed by more than a preset quantity of verification institutions, a block header verified as valid will be put on-chain on the consortium blockchain according to a consensus order, and a consortium blockchain block header has a joint signature of multiple institutions. For example, a Practical Byzantine Fault Tolerance (PBFT) consensus algorithm is adapted for both the private blockchain and the consortium blockchain. A difference lies in that in the private blockchain, each node has one vote. When more than ⅔ of nodes verify that transaction data is correct and vote in favor, the transaction data may be put on-chain on a private blockchain ledger; in the consortium blockchain, one institution has one vote. When more than ⅔ of institutions verify that block body data corresponding to a private blockchain block header is correct and vote in favor, the private blockchain block header data may be put on-chain on a consortium blockchain ledger. A block header of the private blockchain after being put on-chain has a member proof of the consortium blockchain, and corresponding transaction data can also have the member proof of the consortium blockchain.

For consensus, private blockchain block data is used as a unit, rather than transaction data (according to characteristics of a UTXO transaction, a block may be regarded as an affair data containing multiple inputs and multiple outputs). More than, for example, ⅔ of institutions verify and pass the consensus, that is, it will be put on-chain on the consortium blockchain. That is to say, institutions are a plurality of users of the consortium blockchain, and “user data” submitted by the users (institutions) is block data of the private blockchain, and the consortium blockchain is consensus-obtained through mergeable block data (or mergeable affair data).

A token of a solution of an embodiment of the present disclosure has an identifier, different consortium blockchains issue tokens with different identifiers, and a private blockchain of an institution A may participate in two or more different consortium blockchains at the same time. Tokens issued by different consortium blockchains have identifiers. For example, a consortium 1 uses token1, a consortium 2 uses token2, and the institution A may issue token1, which needs to be verified by the consortium 1 (the consortium 1 only needs to verify that the institution A's private blockchain token1 has a cross-chain transaction with itself), and the consortium 1 does not verify a non-token1 issued by the institution A, nor does it verify a non-token1 transaction of the institution A, for example, a non-token1 generated by the institution A trades with a non-consortium 1; similarly, the institution A may issue token2, which needs to be verified by the consortium 2 (the consortium 2 only needs to verify that the institution A's private blockchain token2 has a cross-chain transaction with itself), and the consortium 2 does not verify a non-token2 issued by the institution A, nor does it verify a non-token2 transaction of the institution A, for example, a non-token2 generated by the institution A trades with a non-consortium 2. Therefore, a private blockchain of the institution A may participate in the consortium 1 and the consortium 2 at the same time. The consortium 1 and the consortium 2 only need to verify boundaries of token1 and token2 transactions, respectively, which can ensure that token1 and token2 are deterministic in the consortium 1 and the consortium 2, respectively. At the same time, a consortium blockchain is generated after isolation and verification, which can ensure that no information is leaked to another consortium, because cross-chain is only within a present consortium, and transaction data will not have any conflict.

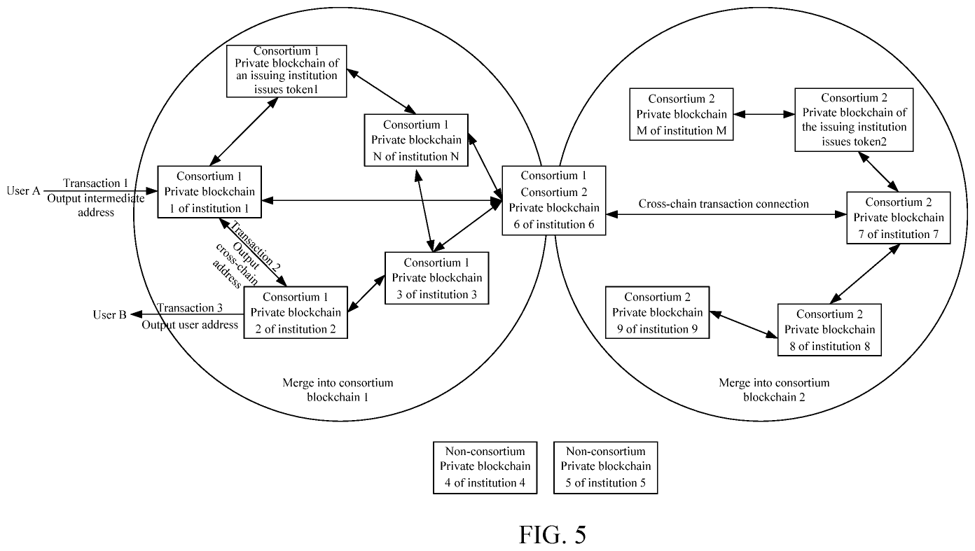

As shown in FIG. 5, in FIG. 5, each institution manages its own one private blockchain (one private blockchain may contain multiple nodes), and each institution's private blockchain is independent and logically isolated. An institution may participate in multiple consortiums at the same time or may not participate in a consortium. However, if a cross-chain transaction is needed, it needs to participate in a corresponding consortium to cross a chain. Logically isolated UTXO chains are connected through a cross-chain transaction address. A token issued by an issuing institution within a consortium is deterministic and can only be circulated within the consortium. For example, for a private blockchain 4 of a non-consortium institution 4, if a token 1 needs to be circulated, it may join a consortium blockchain 1. In FIG. 5, a private blockchain 6 of an institution 6 joins a consortium 1 and a consortium 2. The private blockchain 6 of the institution 6 may circulate a token1 with an institution within the consortium 1, and similarly may circulate a token2 with an institution within the consortium 2. A total amount of token1 in the consortium 1 and a total amount of token2 in the consortium 2 are all deterministic, and tokens may be issued or recycled by a specialized institution within a consortium. Another institution within the consortium only circulates a token, so the private blockchain 6 may participate in merging into the consortium blockchain 1 and a consortium blockchain 2 at the same time.

A token amount of an issuing or recycling transaction of a private blockchain is in plain text, and a total token amount in an institution may be verified before a private blockchain of the institution is put on-chain on a consortium blockchain. Therefore, it is necessary for a mode in which a transaction issued by an institution can obtain automatical verification of all institutions of the consortium blockchain. An issuing address is a special input address of an issuing transaction and is unique and has no referenced transaction data. Therefore, an off-chain issuing verification data may be signed by all participating institutions, the issuing verification data does not belong to ledger data, even if modified, it will not change a private blockchain or consortium blockchain, and its function is only to enable automatic verification on the issuing transaction when a private blockchain of an institution is verified. For example, when an institution 1 is a member of the consortium blockchain and the institution 1 issues tokens, another member institution of the consortium blockchain verifies an amount of tokens issued by the institution 1 and sign corresponding issuing verification data. The issuing verification data contains information such as an issuing institution ID and an issuing amount, and may also contain a corresponding issuing address, and requires a joint signature of all participating institutions. Off-chain issuing verification data may be provided through public service of the consortium blockchain. Another institution in a consortium verifies an amount of tokens issued by the institution 1 (verifies whether it is qualified to issue the amount of tokens, for example, verifies whether it has equivalent credit assets), and signs issuing verification data corresponding to the tokens. After being verified as passed and being signed, private blockchain data may be put on-chain on the consortium blockchain. When a running private blockchain needs to issue a token, all institutions of the consortium blockchain also need to jointly sign issuing verification data before an issuing transaction can be generated. Similarly, the institution 1 can also verify an amount of tokens issued by another member institution of the consortium blockchain when the tokens are issued by the member institution, and sign issuing verification data corresponding to the tokens.

A solution of an embodiment of the present disclosure may achieve that each institution can generate private blockchain ledger data without conflict, and the ledger data may be kept secret through address commitment and homomorphic encryption or another encryption mode (for example, symmetrical encryption protects a transfer-money contract, and other institutions cannot decrypt and verify contract data), so institutions may mutually verify ledger data, and a DHT cluster with a trusted execution environment may be used for isolating and verifying the ledger data, because through connected storage, huge UTXO chain transaction data may be stored in a distributed manner and verified in the DHT cluster by means of key-value, and each node only needs to store and verify part of the ledger data, then entire ledger data can be jointly verified. The DHT cluster may be jointly participated by institutions of the consortium blockchain, private blockchain ledger data of each institution can be jointly verified, and the consortium blockchain is consensus-generated by a block header of a private blockchain. And through the Trusted Execution Environment (TEE), private blockchain ledger data is isolated and verified to ensure data security of a private blockchain of an institution. A consortium blockchain generated in this way is equivalent to that a private blockchain block header serves as intermediate layer data, and what it points to (a private blockchain block body) is an under-chain transaction data ledger of the consortium blockchain. Therefore, the solution of the present disclosure can protect data security of an institution to a great extent, which is beneficial for institutions that do not need trust to participate in the consortium blockchain with each other, and each institution independently generates its own private blockchain, and the consortium blockchain is consensus-generated using a private blockchain block header only after being verified as passed, which will not affect an internal business of an institution adversely.

In an exemplary embodiment, intermediate layer data (private blockchain block headers) of a plurality of consortium blockchains may also be merged to form a larger consortium blockchain data. Since cross-chain needs to wait for generation of the consortium blockchain before it can be carried out, a local consortium blockchain can perform cross-chain more quickly. Since they are all logically isolated UTXO chain ledger data and across-chain connection mode is specified, they will not be affected by a merging mode.

If more transparent ledger data is desired, transaction data of a private blockchain may be merged directly, and then a block header of a consortium blockchain may be consensus-generated, and the ledger data may be publicly verified and reviewed. Since the transaction data is also encrypted and protected, only a corresponding user and institution can decrypt a transaction amount, contract plaintext, and other information, and others may verify the ledger data, but they do not know transaction information. That is to say, a contract is an internal application of an institution, and a private blockchain ledger records a corresponding result. Different institutions within a consortium may handle different contracts according to different businesses on their own. A consortium blockchain ledger verifies whether a transaction result of the private blockchain is correct and ledgers are merged. Since transaction data of a private blockchain ledger of an institution is transaction data of a UTXO chain, an internal contract of the institution is separated from the transaction data of the private blockchain ledger of the institution, and only a corresponding user can decrypt and view encrypted and protected contract information in the transaction data, and can verify whether a contract result is correct. Others and another institution may verify whether a UTXO chain formed by private blockchain transaction data of the institution is correct, that is, whether token circulation is correct, and a merged consortium blockchain can ensure that a token within the consortium is correct.

In an exemplary embodiment, a merging process is as follows: after a certain permission chain generates new block data, the block data is verified by a verifier of the consortium blockchain, and it is necessary to verify whether an unspent transaction referenced by a data input to be put on-chain has a member proof of the consortium blockchain, that is, to ensure that data put on-chain on the consortium blockchain are all unspent outputs on the referenced consortium blockchain, so that cross-permission chain transactions are merged and then are converted into transactions within the consortium blockchain. After successful verification, a block header hash value for indicating a restricted consortium blockchain block height is added to permission chain block header data, that is, a maximum block height corresponding to an unspent output on the consortium blockchain referenced by a cross-permission chain transaction in a block. If a permission chain block does not contain a cross-permission chain transaction, it is equivalent to a block header hash value indicating a restricted consortium blockchain block height corresponding to a previous permission chain block header contained by a permission chain block header, that is, if a cross-permission chain transaction is not contained, a restricted consortium blockchain block height remains unchanged. If a previous block does not contain a cross-permission chain transaction, and is not put on-chain on the consortium blockchain (block headers put on-chain on the consortium blockchain all have block header hash values indicating a restricted consortium blockchain block height), it is necessary to continue recursively forward. If recursively forwarding to an originating block which still does not contain a cross-permission chain transaction, a block header hash value indicating a restricted consortium blockchain block height of a block header is set to a first preset value (e.g., zero).

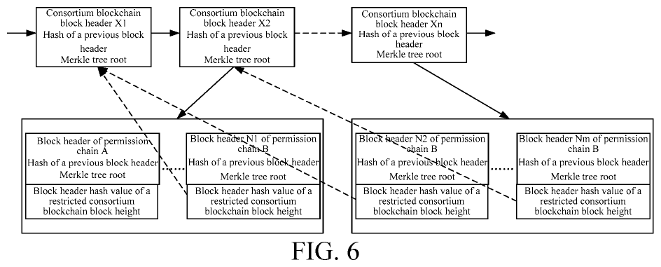

As shown in FIG. 6, a consortium blockchain block header X contains block header data of a plurality of permission chains, exemplarily, block header data having a permission chain A and a permission chain B may also have block header data of another permission chain. Among them, a block header N1 and a block header N2 of the permission chain B have a hash value of a block header X1 indicating a restricted consortium blockchain block height, thus indicating that N1 and N2 can only be put on-chain on a consortium blockchain after the consortium blockchain block header X1. Therefore, N1 is put on-chain on a consortium blockchain block X2 and N2 is put on-chain on a consortium blockchain block Xn. And block header data of the permission chain B is not contained between the consortium blockchain block X2 and the consortium blockchain block Xn, but only block header data of another permission chain is contained, so the block header data of the permission chain B is sequentially put on-chain on the consortium blockchain. Similarly, the consortium blockchain block Xn also includes a block header Nm of the permission chain B, which means that a block of the consortium blockchain may contain multiple block header data of a certain permission chain, but it is also required to be put on-chain sequentially. Through these two conditions, it is ensured that an input reference of UTXO transaction data of a permission chain corresponding to being put on-chain on the consortium blockchain is a forward unspent output on the consortium blockchain, and will not be affected by bifurcation of the consortium blockchain.

Then, a verifier endorses and signs block header data, and sends it to a bookkeeper of the consortium blockchain, and the bookkeeper consensus-puts on-chain the block header data on the consortium blockchain. Similarly, after a private blockchain of another system generates new block data, it is also verified and block header data is consensus-put on-chain.

The bookkeeper of the consortium blockchain needs to ensure that a previous permission chain block header data contained in permission chain block header data is put on-chain on the consortium blockchain before this, and there are no other block header data of the permission chain thereafter, that is, block headers of the permission chain are sequentially put on-chain. And a block header hash value, for indicating a restricted consortium blockchain block height, corresponding to the permission chain block header is equal to a certain forward consortium blockchain block header hash value. If a hash value is a first preset value, a block height putting on-chain on the consortium blockchain is not restricted, since no unspent output of another permission chain is referenced, putting on-chain on the consortium blockchain may be at any block height. Since transactions in a permission chain block may be categorized into two types: a transaction within the permission chain and a cross-permission chain transaction. These two conditions guarantee validity of the transaction within the permission chain being put on-chain on the consortium blockchain and validity of the cross-permission chain transaction being put on-chain on the consortium blockchain, respectively, because sequentially putting on-chain of permission chain block headers can guarantee that the transaction within the permission chain references a forward unspent output within the permission chain. And if the consortium blockchain has bifurcation, through a block header hash value for indicating a restricted consortium blockchain block height, it can be ensured that transaction data, after being put on-chain on consortium blockchain, satisfies that an input references a forward unspent output on the consortium blockchain.

The bookkeeper verifies that block headers of a certain permission chain are put on-chain on the consortium blockchain sequentially, and also needs to verify whether a first block header of the permission chain put on-chain on the consortium blockchain is valid. If a block header hash value contained in the first block header indicating a restricted consortium blockchain block height is not a first preset value, it cannot be verified whether it is a valid first block header, because a previous block of the permission chain may contain cross-chain transaction data. Therefore, a block header hash value contained in a first block header of a permission chain put on-chain on the consortium blockchain which indicates a restricted consortium blockchain block height must be the first preset value, to indicate that no cross-chain transaction data is contained in a previous block of the permission chain. If a current block of the permission chain does not contain a cross-permission chain transaction, and a previous block of the permission chain contains a cross-permission chain transaction, since permission chain block headers are sequentially put on-chain on the consortium blockchain, a block header hash value of a current block header indicating a restricted consortium blockchain block height may be set to a second preset value (for example, FF . . . FF). Permission chain block header data containing the second preset value also does not restrict a block height putting on-chain on the consortium blockchain, but indicates that a previous block of the permission chain contains a cross-permission chain transaction and cannot be used as a first block header data put on-chain on the consortium blockchain, and a block height putting on-chain on the consortium blockchain is implicitly restricted by sequential putting on-chain, this is because putting on-chain on the consortium blockchain must be performed after the block (including a cross-chain transaction) height put on-chain on the consortium blockchain is explicitly restricted.

The merged consortium blockchain has a two-layer structure, as shown in FIG. 3a. A first layer is an intermediate layer of the consortium blockchain (including block header data of a private blockchain (permission chain)), and a second layer is ledger data of the consortium blockchain (that is, block data corresponding to a block header of the private blockchain (permission chain)). Therefore, before transaction data of the private blockchain is put on-chain on the consortium blockchain, it only has a member proof of the private blockchain, and after being put on-chain on the consortium blockchain, there is a member proof of the consortium blockchain, and the proof also has two layers. The consortium blockchain uses a two-layer structure, and an actual data volume of the first layer required to be merged and generated is very small, which may support merging of multiple private blockchains with a large amount of ledger data, and only data of the first layer is disclosed, thus no private information is leaked.

Therefore, through hierarchical ledgers and multi-level consensus, problems of bookkeeping and security privacy of large-scale ledger data of the consortium blockchain are solved. Several member chains in the consortium blockchain may achieve faster cross-chain transactions between sub-consortiums by means of establishing sub-consortium blockchains. A putting on-chain mode of a sub-consortium blockchain is similar to that of the consortium blockchain, but with fewer participating member chains, and they may trust each other and only a cross-chain transaction is verified, so a cross-chain transaction between sub-consortiums can be completed more quickly. The verifier of the consortium blockchain verifies a cross-permission chain transaction between sub-consortium blockchains, which is verified as a transaction mode within a sub-consortium blockchain, and a cross-permission chain transaction between non-sub-consortium blockchains is verified as a normal cross-chain transaction mode. However, transaction data within a chain only needs to reference an unspent output within the chain, so a block header hash value of a sub-consortium blockchain for indicating a restricted consortium blockchain block height is a maximum block height corresponding to an unspent output on the consortium blockchain referenced by a cross-permission chain transaction between non-sub-consortium blockchains. New first layer block data generated by a sub-consortium blockchain is composed of permission chain block header data of a participating sub-consortium blockchain, and then is packed together and added with a block header hash value for indicating a restricted consortium blockchain block height and is put on-chain on the consortium blockchain, so that it can be guaranteed that a cross-chain transaction between permission chains of the sub-consortium blockchain can be processed as an intra-chain transaction mode of the sub-consortium blockchain.

The private blockchain of the above-mentioned institution may also be a permission chain jointly managed by a plurality of institutions. Whether it is a private blockchain or a permission chain, it corresponds to one subject, the subject contains one or more member institutions, and a related institution ID is also a subject ID or a chain ID. Whether it is a private blockchain of one institution or a permission chain of a plurality of institutions, it may participate in merging into a consortium blockchain, which is not limited in the embodiments of the present disclosure. The consortium blockchain corresponds to multiple subjects, and is obtained by merging N permission chain ledgers of N subjects. And it is possible to merge sub-consortium blockchains into a consortium blockchain. For example, it is achieved by merging block header data of a first layer.

Taking a user Alice of an institution 1, who needs to transfer money to a user Bob of an institution 2, as an example, a process of a cross-chain transaction is illustrated and includes following acts.

1. The user Alice generates an intermediate transaction with the institution 1 (e.g., a transaction 1 in FIG. 5).

An input of an intermediate transaction references Alice's unspent transaction output, an intermediate transaction address Saddr of the institution 1 is output, containing Alice's commitment address and Bob's commitment address, and may also include encrypted transfer-money contract data. A transfer-money contract of a transaction sent by a user contains information (which may be a name or identifier of an institution) of an institution 2 which Bob belongs to and transfers money to Bob, and an output commitment amount is a sum of input commitment amounts. Among them, the output intermediate transaction address needs to be ensured to be unique, so a referenced user address (which is guaranteed to be unique by the institution) may be used and its type is replaced with a type of an intermediate transaction address. Since the institution 1 cannot manage Bob, when the institution 1 verifies intermediate transaction data, it needs to query institution 2 whether a status of the user Bob is normal and whether a public key is correct. For example, the institution 1 sends a cross-chain transaction address needed to be output, an output commitment address (generated by Bob's public key), an output commitment amount, a cross-chain remark label, and cross-chain remark information to the institution 2. After being verified by the institution 2 as passed, the institution 2 signs the cross-chain transaction address, the output commitment address, the output commitment amount, the cross-chain remark label, and encrypted cross-chain remark information that are packed, and returns them to the institution 1 together with a decryption key used. After being verified by the institution 1, packaged information may be used as a cross-chain output of an obfuscated transaction 2 generated by the institution 1. That is, information of the cross-chain output generated by the institution 1 is confirmed and signed by the institution 2.

For example, Alice acquires Bob's signature public key Pb or Bob's derived public key b*Pb, and an intermediate address Saddr of the institution 1. Alice generates random numbers ra1, ta1, rb1, tb1, ra1, ta1, rb1, and tb1∈(0, n) and generates a set of commitment addresses for all receivers, including Alice's commitment address Ca1=ra1*Pa+ta1*H and Bob's commitment address Cb1=rb1*Pb+tb1*H. An intermediate transaction is then generated, a transaction output address is Saddr, the address is a special intermediate transaction address, and the address can only be used for transferring money to an output address associated with a user commitment address (Ca1 and/or Cb1). Alice uses a private key corresponding to an unspent transaction output address referenced by an intermediate transaction to sign the intermediate transaction and generate an unlocking script. Alice submits the intermediate transaction and informs the institution 1 of coefficients ra1, ta1, rb1, and tb1 of a commitment address, and the institution 1 verifies the commitment address.

A commitment address of a user may be generated in a following manner: C=r*P+t*H, wherein C is the commitment address of the user, P is a signature public key of the user, H is a first generator, r is a first coefficient, and t is a second coefficient. In other embodiments, a commitment address may be calculated using a user's signature derived public key b*P, i.e., C=r*(b*P)+t*H, wherein b is a fourth coefficient. r, t, and b are all random numbers, and r, t, and b∈(0, n). A signature derived public key (referred to as a derived public key for short) is obtained by an operation of a user's signature public key P and a coefficient b, and a generation parameter a may also be presented, wherein b may be a hash value obtained by an operation of a and a user's generation key s, for example, b=H3(s, a), wherein H3 is a hash function. Therefore, users may obtain their own derived public key according to the generation parameter a, but they only know the derived public key and the generation parameter, and it is impossible to infer whose signature public key is operated to obtain them. The user signature public key P=d*G, d is a corresponding private key, and G is a generator on an elliptic curve. H is another generator on the elliptic curve, and nobody knows a private key of H relative to G, that is, it is impossible to find a scalar x such that H=x*G. By subtracting t*H from a commitment address, a primary public key generated by the user's signature public key P may be obtained, for example, C−t*H=r*P.

2. The institution 1 generates an obfuscated transaction 1 or generates an obfuscated transaction 2.

If Bob is a user of the institution 1, the obfuscated transaction 1 (a transaction between the user and an institution) is generated, in which an intermediate transaction output address Saddr of Alice and institution 1 is referenced, and an output includes Alice's change output and Bob's transfer-money output, an output user address is guaranteed to be unique by the institution 1 and is associated with an output commitment address, and an output amount is obtained through a transfer-money contract of an intermediate transaction, and a commitment amount mode is used.

For example, one input of multiple inputs of a transaction references Saddr and a commitment address to be transferred money is contained in the input, such as Ca1 and Cb1, the commitment address can only be an element in a set of commitment addresses contained in an intermediate transaction of the referenced Saddr, and each commitment address is added with a commitment address and a signature generated by S, respectively, for example, Ca1 is added with Ca2 and a signature, to form an input commitment address pair (Ca1, Ca2), wherein Ca2=ra2*Pa+ta2*H. Likewise, Cb1 is added with Cb2 and a signature to form an input commitment address pair (Cb1, Cb2), wherein Cb2=rb2*Pb+tb2*H, ra2, ta2, rb2, and tb2 are values generated by S. All input commitment addresses are equal to all output commitment addresses through operation.

If Bob is a user of the institution 2, the obfuscated transaction 2 (a transaction between institutions, such as a transaction 2 in FIG. 5) is generated, compared with the obfuscated transaction 1, an only difference is that an output for Bob is not a user address, but a cross-chain transaction address. This address contains an ID of an institution (the institution 1 in this example) that generated the obfuscated transaction 2and an ID of a cross-chain institution (the institution 2 in this example). Output information is signature package information returned by the institution 2, i.e., including a cross-chain transaction address, an output commitment address, an output commitment amount, a cross-chain remark label (optional), an encrypted cross-chain remark information (optional), and a signature of the institution 2. Encrypted remark information of Alice may contain a key and a random number r2 used for decrypting remark information and returned by the institution 2. The cross-chain transaction address output by the obfuscated transaction 2 is similar to an intermediate transaction address output by an intermediate transaction, and similarly contains a user's commitment address and commitment amount, which may be used as an input of a next obfuscated transaction (such as an obfuscated transaction 1 or an obfuscated transaction 2), and a referenced institution may sign to complete unlocking, and multiple obfuscated transactions 2 may be contained in between to achieve transactions across multiple institutions. And an output of a referenced cross-chain transaction already contains a cross-chain remark label (r2*G and r2*Pb, wherein Pb is a public key of the user Bob) and encrypted cross-chain remark information, so Bob may find the label and decrypt it, and a decryption key may be in the remark information (similarly Alice's decryption key is in remark information).

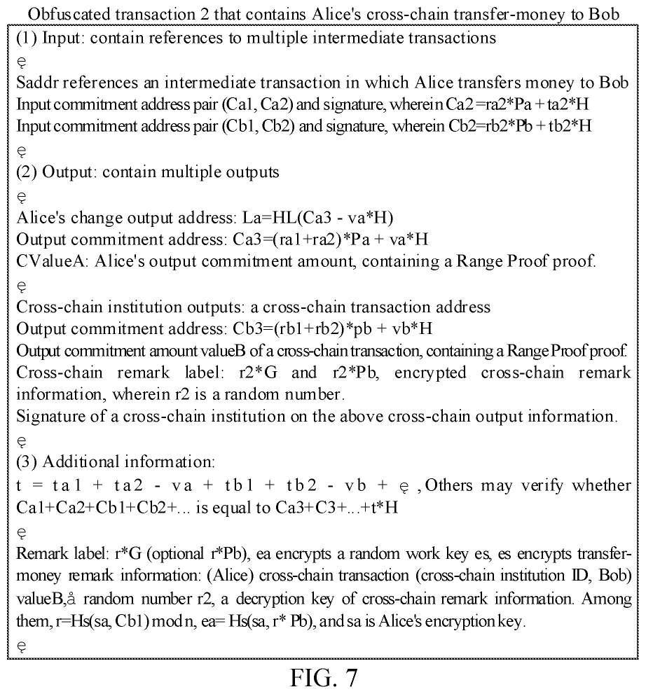

For example, as shown in FIG. 7, an output of the obfuscated transaction 2 includes Alice's change output address, that is, Alice's primary address: La=HL(Ca3−va*H), Alice's output commitment address Ca3=(ra1+ra2)*Pa+va*H, and CValueA is Alice's output commitment amount, including a Range Proof proof. The output of the obfuscated transaction 2 further includes a cross-chain transaction address, Bob's output commitment address Cb3=(rb1+rb2)*Pb+vb*H, and an output commitment amount valueB of a cross-chain transaction includes a Range Proof proof. Additional information of a transaction includes a parameter t which is a sum of H coefficients of all input commitment addresses minus a sum of H coefficients of all output commitment addresses. So it may be verified whether a sum of input commitment addresses is equal to a sum of output commitment addresses plus t*H. That is, whether Ca1+Ca2+Cb1+Cb2+ . . . is equal to Ca3+Cb3+ . . . +t*H, wherein t=ta1+ta2−va+tb1+tb2−vb+ . . . . In this example, the obfuscated transaction 2 further includes a remark, a label of the remark is r*G or r*Pb, wherein r=Hs (sa, Cb1) mod n, Hs is a hash function, and sa is Alice's encryption key. S randomly generates an encryption key es, es is used for encrypting cross-chain transfer-money remark information, and ea is used for encrypting a random work key es, wherein ea=Hs (sa, r*Pb) is Alice'S encryption key (in the formula, Pb may be replaced by G), and remark information may be (Alice) cross-chain transaction (cross-chain institution ID, Bob) and a value transferred money to Bob.

3. The institution 2 generates an obfuscated transaction 1.

The institution 1 presents a generated obfuscated transaction 2 and corresponding putting on-chain information, that is, a member proof of a transaction in a consortium blockchain, to the institution 2. After the institution 2 verifies that relevant data is correct, it generates the obfuscated transaction 1 (for example, a transaction 3 in FIG. 5), which contains a cross-chain transaction address referenced by an input. A generated remark label for Bob use a referenced cross-chain remark label (r2*G and r2*Pb), and remark information contains a decryption key for corresponding cross-chain remark information. Bob may verify db*(r2*G)=r2*Pb according to a private key db corresponding to Pb, so Bob may find the cross-chain remark information and decrypt it, and then Bob may verify whether an output commitment amount is correct.

So Alice, a sender (including the institution 1) of the cross-chain transaction may view information of an entire process and verify it, confirming that Bob, a receiver, has received a corresponding amount. However, neither Alice nor the institution 1 knows Bob's output address, while neither Bob nor the institution 2 knows Alice's input address nor Alice's input amount, thus protecting privacy of an institution and user data. Both parties may know a cross-chain transaction address, the address is only an input and output address of the cross-chain transaction, not an input and output address of a user. And cross-chain output information is signed by institutions of both parties (output information contained in transaction data is signed by the institution 2, and the transaction data is signed by the institution 1), so correctness of the cross-chain output information can be ensured.

Similarly, an offline transaction also has an institution ID, for example, an offline transaction address is (institution ID+offline transaction signature public key), so users of different institutions can also conduct transactions offline. For example, Alice, a user of the institution 1, generates an intermediate transaction, and a contract is Alice's offline transaction request, including Alice's offline transaction signature public key and derived public key, and a delayable parameter is log information of Alice sending a transaction offline; Bob, a user of the institution 2 also generates an offline transaction request, containing Bob's offline transaction signature public key and derived public key.

Alice and Bob generate offline transaction data, and log information is an offline transaction address of the sender Alice, Bob's commitment address, nonce random number, and a signature of Alice's offline transaction signature private key. Offline transaction data must have signatures of users of both parties of a transaction. Alice synchronizes the offline transaction data to the institution 1, and a log of sending a transaction offline is used as a delayable parameter of an offline transaction request contract, which is encrypted and stored in remark information of an on-line obfuscated transaction between Alice and the institution 1, and a transfer-money amount with the institution 1 is a total cost of Alice sending a transaction offline.

Similarly, Bob synchronizes offline transaction data to the institution 2, a log of receiving a transaction offline is encrypted as remark information of an offline transaction (record), and a sum of commitment addresses in a remark is used as a commitment address in an offline transaction (record) input, and forms an input commitment address pair with an additional commitment address generated by the institution 2. An output is consistent with an online obfuscated transaction, but it does not need to be obfuscated, because the offline transaction (record) has only an institution and one user, and is not associated with another user, so user privacy is not revealed even if it is not obfuscated. An input amount of the offline transaction (record) is an unspent transaction output of the institution 2, so the institution 2 transfers money to the user Bob, and an output amount is a total income of Bob receiving a transaction offline.

If users of both parties of an offline transaction are in a same institution, the institution may directly handle an offline transaction amount of both parties; if they are in different institutions, mutual confirmation is required between the institutions, and an institution that sends a transaction offline performs cross-chain transfer-money to an institution that receives a transaction offline. Therefore, a user of the consortium blockchain may also perform an offline transaction and completely record log information on a chain. If double expenditure occurs, an institution will hold the user accountable.

In an embodiment of the present disclosure, one transaction data of a user is split into two or more transaction data, for example, an intermediate transaction between a sender and an institution, and an obfuscated transaction 1 between the institution and a receiver. A cross-chain transaction address (an obfuscated transaction 2) may be contained in an output of the obfuscated transaction 1, and an input of the obfuscated transaction 1 generated by a corresponding cross-chain institution references the cross-chain transaction address. Output information of the cross-chain transaction address may contain a signature of an institution 2, that is, the output information is confirmed by both institutions. Therefore, one or more obfuscated transactions 2 may be contained in between to achieve a transaction across one or more chains (institutions). An obfuscated transaction 2 may contain an intermediate transaction address (a non-user address) and may be a non-cross-chain transaction output.

An exemplary embodiment of the present disclosure also provides a computer storage medium that stores a computer program; when the computer program is executed, the method provided by one or more of the foregoing exemplary embodiments may be implemented, for example, one or more of methods shown in FIG. 1 to FIG. 2 may be implemented. The computer storage medium includes volatile and nonvolatile, and removable and irremovable media implemented in any method or technology for storing information (for example, a computer-readable instruction, a data structure, a program module, or other data). The computer storage medium includes, but is not limited to, a Random Access Memory (RAM), a Read Only Memory (ROM), an Electrically Erasable Programmable Read Only Memory (EEPROM), a flash memory or another memory technology, a Compact Disc Read Only Memory (CD-ROM), a Digital Versatile Disk (DVD) or another optical disk storage, a magnetic cartridge, a magnetic tape, magnetic disk storage or another magnetic storage apparatus, or any other medium that may be used for storing desired information and may be accessed by a computer.

An exemplary embodiment of the present disclosure also provides a computer apparatus (or called a computer device). The computer device may include a processor, a memory, and a computer program which is stored on the memory and is runnable on the processor, operations performed by a private blockchain institution of the present disclosure may be implemented (e.g., the methods of FIG. 1 or FIG. 2 are implemented) when the processor executes the computer program. A structure of the above-mentioned computer apparatus will be described below through an example.

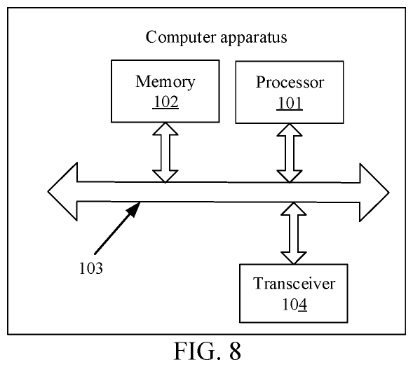

As shown in FIG. 8, in one example, a computer device may include a processor 101, a memory 102, a bus system 103, and a transceiver 104, wherein the processor 101, the memory 102, and the transceiver 104 are connected through the bus system 103. The memory 102 is used for storing instructions and the processor 101 is used for executing instructions stored in the memory 102 to control the transceiver 104 to send a signal.

It should be understood that the processor 101 may be a Central Processing Unit (CPU), and the processor 101 may also be another general-purpose processor, a Digital Signal Processor (DSP), an Application Specific Integrated Circuit (ASIC), a Field Programmable Gate Array (FPGA) or another programmable logic device, a discrete gate or a transistor logic device, and a discrete hardware component, etc. The general-purpose processor may be a microprocessor, or the processor may be any conventional processor, etc.

The memory 102 may include a read only memory and a random access memory, and provides instructions and data to the processor 101. A part of the memory 102 may also include a non-volatile random access memory. For example, the memory 102 may also store information of a device type.

The bus system 103 may include a power bus, a control bus, a status signal bus, or the like in addition to a data bus. However, for clarity of illustration, all buses are denoted as the bus system 103 in FIG. 8.

In an implementation process, processing performed by the computer device may be completed through an integrated logic circuit of hardware in the processor 101 or instructions in a form of software. That is, acts of the methods disclosed in the embodiments of the present disclosure may be embodied as executed and completed through a hardware processor, or executed and completed through a combination of hardware in the processor and a software module. The software module may be located in a storage medium such as a random access memory, a flash memory, a read only memory, a programmable read only memory, or an electrically erasable programmable memory, and a register. The storage medium is located in the memory 102. The processor 101 reads information in the memory 102, and completes the acts of the above methods in combination with its hardware. In order to avoid repetition, detailed description is not provided herein.

Adopting the address generation method and the transaction data processing method in the chain structure of the embodiments of the present disclosure, by using a unique identifier of a subject in an address, ledger data generated by each subject will not conflict, data isolation of different permission chains (private blockchains) may be achieved, logically isolated TXO transaction data chains are connected with each other through a transaction address across a permission chain (private blockchain), and merging of logically isolated TXO transaction data chains may be achieved. A bookkeeping process without transaction data is achieved through block header data and a block header hash value that restricts a block position, and permission chain ledgers of a plurality of subjects are merged into a logical general ledger, which is beneficial for subjects that do not need to be trusted to participate in transactions mutually, such as different subjects in different countries and regions, and can have higher credibility and consortium tokens of a wider circulation range, that is, tokens of the logical general ledger.

It may be understood by those of ordinary skill in the art that all or some acts in the method and function modules/units in the system and the apparatus disclosed above may be implemented as software, firmware, hardware, and appropriate combinations thereof. In a hardware implementation mode, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed in a computer-readable medium, and the computer-readable medium may include a computer storage medium (or a non-transitory medium) and a communication medium (or a transitory medium). As known to those of ordinary skill in the art, a term computer storage medium includes volatile and nonvolatile, and removable and irremovable media implemented in any method or technology for storing information (for example, computer-readable instructions, a data structure, a program module, or other data). The computer storage medium includes, but is not limited to, a RAM, a ROM, an EEPROM, a flash memory or another memory technology, a CD-ROM, a Digital Versatile Disk (DVD) or another optical disk storage, a magnetic box, a magnetic tape, magnetic disk storage or another magnetic storage apparatus, or any other media that may be used for storing desired information and may be accessed by a computer. In addition, it is known to those of ordinary skill in the art that the communication medium usually includes computer-readable instructions, a data structure, a program module, or other data in a modulated data signal of, such as, a carrier or another transmission mechanism, and may include any information delivery medium.

The above shows and describes basic principles and main features of the present disclosure and advantages of the present disclosure. The present disclosure is not limited by the above embodiments, the above embodiments and the description in the specification are only illustrative of the principles of the present disclosure, and without departing from the spirit and scope of the present disclosure, there will be various changes and improvements in the present disclosure, and these changes and improvements all fall within the scope of the present disclosure claimed to be protected.

1. A chain structure transaction data processing method, wherein the method comprises:
merging Transaction Output (TXO) transaction data chains of a plurality of permission chain ledgers which circulate a same token to generate a TXO transaction data chain of a logical general ledger of the token, wherein the logical general ledger is generated by logically merging the plurality of permission chain ledgers, the logical general ledger contains a two-layer structure, a first layer of ledger data is consensus-generated by a plurality of block header data of a plurality of permission chains, transaction data in ledger data of the permission chains mapped through the block header data of the permission chains serves as a second layer of ledger data of the logical general ledger, and ledger data of the logical general ledger is jointly formed through the mapped transaction data, and the ledger data logically contains transaction data,
wherein a TXO transaction data chain of a permission chain ledger is a directed acyclic graph formed by all spent transaction outputs and all unspent transaction outputs of the token, and a directed acyclic graph of the logical general ledger, namely the TXO transaction data chain of the logical general ledger, is generated by merging directed acyclic graphs of the plurality of permission chains.

2. The method according to claim 1, wherein before the merging the TXO transaction data chains of the plurality of permission chain ledgers which circulate the same token, the method further comprises:
verifying, by a verifier, permission chain block data; after being verified as passed, adding a block header hash value for indicating a restricted block position to permission chain block header data to be put on-chain, wherein the restricted consortium blockchain block position is at least a maximum block position corresponding to an unspent output on the consortium blockchain referenced by a cross-permission chain transaction in the permission chain block.

3. The method according to claim 2, wherein the adding the block header hash value for indicating the restricted block position to the permission chain block header data to be put on-chain, comprises:
when the permission chain block to be put on-chain does not contain a cross-permission chain transaction, recursively forwarding to a previous permission chain block containing a cross-permission chain transaction on the permission chain, finding a permission chain block header pointing to the permission chain block on the consortium blockchain, and adding a block header hash value in the permission chain block header for indicating a restricted consortium blockchain block position to permission chain block header data to be put on-chain at present; or when the permission chain block to be put on-chain does not contain a cross-permission chain transaction, recursively forwarding to a permission chain block containing a cross-permission chain transaction on the permission chain, and adding a second preset value to permission chain block header data to be put on-chain at present.

4. The method according to claim 3, further comprising
setting the block header hash value for indicating the restricted consortium blockchain block position in the permission chain block header data to be put on-chain to a first preset value when recursively forwarding to an originating block, which still does not contain a cross-permission chain transaction, on the permission chain.

5. The method according to claim 2, wherein
the merging the TXO transaction data chains of the plurality of permission chain ledgers which circulate the same token to generate the TXO transaction data chain of the logical general ledger of the token, comprises:
generating the first layer of ledger data of the logical general ledger after performing consensus on a plurality of block header data of a plurality of permission chains added with restricted block positions, wherein ledger data of the permission chains mapped through the block header data of the permission chains serves as the second layer of ledger data of the logical general ledger, ledger data corresponding to the logical general ledger is jointly formed through the mapped transaction data, and the ledger data logically contains transaction data.

6. The method according to claim 5, wherein
the generating the first layer of ledger data of the logical general ledger after performing consensus on the plurality of block header data of the plurality of permission chains added with restricted block positions, comprises: consensus-putting on-chain, by a bookkeeper, information to be put on-chain which meets a condition and is generated by the verifier, wherein the condition comprises, but is not limited to: being verified by more than a preset number of verifiers as passed, meeting a requirement for a restricted block position, and being endorsed and signed by the verifier;
wherein the meeting the requirement for the restricted block position, comprises: a block header hash value, corresponding to a permission chain block header to be put on-chain on the consortium blockchain, indicating a restricted consortium blockchain block position is equal to one of forward consortium blockchain block header hash values; permission chain block headers are sequentially put on-chain on the consortium blockchain, and a first block header data of a permission chain put on-chain on the consortium blockchain contains a first preset value.

7. An address generation method in a chain structure, comprising:
generating a cross-chain transaction address, wherein the address is used when a subject participates in a transaction, through the cross-chain transaction address, logically isolated Transaction Output (TXO) transaction data chains of ledgers of different subjects in a same consortium are connected with each other, and merging of TXO transaction data chains of a plurality of subjects in the same consortium into a TXO transaction data chain of a logical general ledger is achieved.

8. The method according to claim 7, wherein the transaction in which the subject participates comprises:
a first transaction between a first user managed by a first subject and the first subject, and a second transaction between the first subject and a second subject, generated by the first subject according to the first transaction, the second transaction is used for enabling the second subject to generate a third transaction between the second subject and a second user managed by the second subject to achieve a transaction between the first user and the second user.

9. The method according to claim 8, wherein an input of the second transaction comprises one or more references to the first transaction, an output of the second transaction comprises a cross-chain transaction address of the second subject and an output commitment address of the second user, and the cross-chain transaction address is used for the second subject to reference in an input of the third transaction.

10. The method according to claim 7, wherein the cross-chain transaction address comprises: an address type for indicating that a current address is a cross-chain transaction address, a unique identifier of a current subject, a unique identifier of a cross-chain subject, and a unique number.

11. The method according to claim 10, wherein the generated cross-chain transaction address further comprises: a restricted cross-chain block height, referenced by the cross-chain subject within the restricted cross-chain block height or referenced by a current subject after the restricted cross-chain block height, after a second transaction generated by the current subject is put on-chain.

12. A non-transitory computer-readable storage medium having stored thereon computer-executable instructions, wherein the computer-executable instructions are used for executing a method according to claim 1.

13. A computer apparatus, comprising a memory, a processor, and a computer program stored on the memory and runnable on the processor, wherein acts of a method according to claim 1 are implemented when the processor executes the program.

14. A non-transitory computer-readable storage medium having stored thereon computer-executable instructions, wherein the computer-executable instructions are used for executing a method according to claim 7.

15. A computer apparatus, comprising a memory, a processor, and a computer program stored on the memory and runnable on the processor, wherein acts of a method according to claim 2 are implemented when the processor executes the program.

16. A computer apparatus, comprising a memory, a processor, and a computer program stored on the memory and runnable on the processor, wherein acts of a method according to claim 3 are implemented when the processor executes the program.

17. A computer apparatus, comprising a memory, a processor, and a computer program stored on the memory and runnable on the processor, wherein acts of a method according to claim 5 are implemented when the processor executes the program.

18. A computer apparatus, comprising a memory, a processor, and a computer program stored on the memory and runnable on the processor, wherein acts of a method according to claim 7 are implemented when the processor executes the program.

19. A computer apparatus, comprising a memory, a processor, and a computer program stored on the memory and runnable on the processor, wherein acts of a method according to claim 8 are implemented when the processor executes the program.

20. A computer apparatus, comprising a memory, a processor, and a computer program stored on the memory and runnable on the processor, wherein acts of a method according to claim 10 are implemented when the processor executes the program.
